(19) United States
(12) Patent Application Publication
(10) Pub. No.: US 2018/0025401 A1
(43) Pub. Date: Jan. 25, 2018

(54) SYSTEMS AND METHODS FOR INTEGRATING MULTI-MEDIA, FINANCIAL, MERCHANT, AND CONSUMER DATA

(71) Applicant: AIRSHARE TECHNOLOGIES, LLC, Santa Barbara, CA (US)

(72) Inventors: Jeffrey M. Suhadolnik, San Diego, CA (US); Kevin Whelan, Santa Barbara, CA (US); Chris Howell, Poinciana, FL (US)

(21) Appl. No.: 15/613,019

(22) Filed: Jun. 2, 2017

Related U.S. Application Data
(60) Provisional application No. 62/344,534, filed on Jun. 2, 2016.
(60) Provisional application No. 62/427,012, filed on Nov. 28, 2016.

(51) Int. Cl. G06Q 30/06; G06Q 20/12

(52) U.S. Cl. CPC G06Q 30/0609; G06Q 20/123; G06Q 30/0635

(57) ABSTRACT

A data integration system for use by a plurality of customers and a plurality of merchants comprising a control system, at least one customer interface, and at least one merchant interface. The control system displays at least one vender list to customers initiating gift processes. The control system generates gift data based on gift processes initiated by customers and merchants. The control system displays to gift recipients the at least one media clip associated with gift. The control system allows the recipient to change the merchant ID in the gift data. The control system displays to the giver at least one the media clip associated with media data of a transaction.

### RELATED APPLICATIONS

This application, U.S. application Ser. No. 15/613,019 filed Jun. 2, 2017, claims benefit of U.S. Provisional Application Ser. No. 62/344,534 filed Jun. 2, 2016, now expired.

This application, U.S. application Ser. No. 15/613,019 filed Jun. 2, 2017, also claims benefit of U.S. Provisional Application Ser. No. 62/427,012 filed Nov. 28, 2016, currently pending.

The contents of all related applications are incorporated herein by reference.

### TECHNICAL FIELD

The present invention relates to systems and methods for integrating data and, in particular, to systems and methods that facilitate the integration of multi-media, financial, merchant, and customer data.

### BACKGROUND

The Internet facilitates the distribution of data. Data distributed over the Internet is, at a fundamental level, digital data represented by a binary system. In the context of the Internet, digital data is typically configured to represent higher level data such as text, audio, images, animations, and video. The text, audio, images, animations, and video represented by digital data can be reproduced with appropriate hardware. For example, text, images, animations, and video data may be displayed using a monitor, and audio data can be reproduced by a speaker. The need exists for systems and methods for integrating media data, financial data, merchant data, and customer data to facilitate commercial transactions among multiple customers and multiple merchants.

### SUMMARY

The present invention may be embodied as a data integration system for use by a plurality of customers and a plurality of merchants, comprising a control system, at least one customer interface system associated with each customer, and at least one merchant interface system associated with each merchant. The at least one customer interface system associated with each customer, where each customer interface system is operatively connected to the control system to allow customers to enter into the control system customer data associated with each customer, enter into the control system media data associated with media clips, initiate gift processes, initiate redemption transactions, and view media clips based on media data. The control system generates a customer ID associated with each customer, and the media data includes a media ID associated with each media clip. The at least one merchant interface system associated with each merchant, where each merchant interface system is operatively connected to the control system to allow merchants to enter into the control system merchant data associated with each merchant, enter into the control system media data associated with media clips, initiate gift processes, and participate in redemption transactions initiated by customers. The control system generates a merchant ID associated with each merchant. The media data includes a media ID associated with each media clip. The control system defines at least one merchant list based on associations among merchants, where each merchant list includes at least one merchant ID. The control system displays on the customer interface systems the at least one vender list to customers initiating gift processes. The control system generates gift data based on gift processes initiated by customers and merchants, where the gift data includes a gift ID, at least one gift value, at least one giver ID associated with at least one customer or merchant, at least one recipient ID associated with at least one customer, at least one media ID, and at least one merchant ID. The control system displays on the customer interface system to the at least one customer associated with the at least one recipient ID the at least one media clip associated with the at least one media ID of the gift data. The control system allows at least one customer associated with at least one recipient ID to change the merchant ID in the gift data associated with that at least one recipient ID. The control system generates transaction data based on the redemption transaction initiated by the at least one customer associated with each gift ID, where the transaction data includes a transaction ID, a redemption value, at least one media ID, and at least one merchant ID. The control system validates the redemption transaction based on a comparison of the at least one gift value and the merchant ID associated with each gift ID with the redemption value and merchant ID associated with each transaction ID associated with that gift ID. The control system initiates payment to the at least one merchant associated with each transaction ID associated with validated redemption transactions. The control system displays on the customer interface system to the customer associated with the giver customer ID or on the merchant interface system to the merchant associated with the giver customer ID the at least one the media clip associated with the media data of the transaction data.

The present invention may also be embodied as a method of integrating data for use by a plurality of customers and a plurality of merchants, the comprising the following steps. At least one customer interface system is provided to allow the customers to enter into a User database customer data associated with each customer, where a customer ID is associated with each customer, and enter into a Media database media data associated with media clips, where the media data includes a media ID associated with each media clip entered by the customers. At least one merchant interface system is provided to allow merchants to enter into the User database merchant data associated with each merchant, where a merchant ID is associated with each merchant, and enter into the Media database media data associated with media clips, where the media data includes a media ID associated with each media clip entered by the merchants. At least one merchant list is defined based on associations among merchants, where each merchant list includes at least one merchant ID. The at least one vender list is displayed on the customer interface systems to customers initiating gift processes. Gift data is generated based on gift processes initiated by customers and merchants, where the gift data includes a gift ID, at least one gift value, at least one giver ID associated with at least one customer or merchant, at least one recipient ID associated with at least one customer, at least one media ID, and at least one merchant ID. The customer interface system is used to display to the at least one customer associated with the at least one recipient ID the at least one media clip associated with the at least one media ID of the gift data. At least one customer associated with at least one recipient ID is allowed to change the merchant ID in the gift data associated with that at least one recipient ID. Transaction data is generated based on the redemption transaction initiated by the at least one customer associated with each gift ID, where the transaction data includes a transaction ID, a redemption value, at least one media ID, and at least one merchant ID. The redemption transaction is validated by comparing the gift value and the merchant ID associated with the gift ID with the redemption value and merchant ID associated with each transaction ID associated with that gift ID. Payment is initiated to the at least one merchant associated with each transaction ID associated with validated redemption transactions. The at least one media clip associated with the media data of the transaction data is displayed on the customer interface system to the customer associated with the giver customer ID or on the merchant interface system to the merchant associated with the giver customer ID.

### BRIEF DESCRIPTION OF THE DRAWINGS

FIG. 1 is a block diagram illustrating hardware and software systems that may be configured to form an example data integration system of the present invention;

FIG. 2 is a simplified block diagram illustrating an example of the hardware systems that may be used to form the example data integration system of the present invention;

FIG. 3 is a flow chart illustrating one example method of implementing the example data integration method of the present invention;

FIGS. 4A-4B is a swim lane process flow diagram depicting example merchant onboarding and configuration of the merchant marketplace processes;

FIGS. 5A-5B is a swim lane process flow diagram depicting an example merchant promo process;

FIGS. 6A-6B is a swim lane process flow diagram depicting a merchant build process;

FIGS. 7A-7C is a swim lane process flow diagram depicting a consumer build process;

FIGS. 8A-8B is a swim lane process flow diagram depicting group build and consumer build processes;

FIGS. 9A-9B is a swim lane process flow diagram depicting receive gift, consumer notification of received gift, consumer recipient reply processes

FIGS. 10A-10C redeem gift, receive alert/access gift, change gift amount, exchange gift merchant, gift redemption transaction processes;

FIGS. 11A and 11B are screen shots of an example user interface of an example of a data integration system of the present invention that may be presented to a customer during a View Gift step;

FIG. 12 is a screen shot of an example user interface of an example of a data integration system of the present invention that may be presented to a customer during an Add Gift Recipient step;

FIG. 13 is a screen shot of an example user interface of an example of a data integration system of the present invention that may be presented to a customer during a Phone Contacts Accessed step;

FIG. 14 is a screen shot of an example user interface of an example of a data integration system of the present invention that may be presented to a customer during a Confirm Gift Recipient step;

FIG. 15 is a screen shot of an example user interface of an example of a data integration system of the present invention that may be presented to a customer during a Merchant Amount and Promotion Chosen step;

FIG. 16 is a screen shot of an example user interface of an example of a data integration system of the present invention that may be presented to a customer during a Personalize Gift step;

FIG. 17 is a screen shot of an example user interface of an example of a data integration system of the present invention that may be presented to a customer during a User Generated Video step;

FIG. 18 is a screen shot of an example user interface of an example of a data integration system of the present invention that may be presented to a customer during an Enter Text and/or Emoji step;

FIG. 19 is a screen shot of an example user interface of an example of a data integration system of the present invention that may be presented to a customer during a Send Gift step;

FIG. 20 is a screen shot of an example user interface of an example of a data integration system of the present invention that may be presented to a customer during a Schedule Reminder step;

FIG. 21 is a screen shot of an example user interface of an example of a data integration system of the present invention that may be presented to a customer during a Group Invite step;

FIG. 22 is a screen shot of an example user interface of an example of a data integration system of the present invention that may be presented to a customer during a Share to Social Media step;

FIG. 23 is a screen shot of an example user interface of an example of a data integration system of the present invention that may be presented to a customer during a Change Amount (Gift Value) step;

FIG. 24 is a screen shot of an example user interface of an example of a data integration system of the present invention that may be presented to a customer during a Create New Contact step;

FIG. 25 is a screen shot of an example user interface of an example of a data integration system of the present invention that may be presented to a customer during a Gift Notification step;

FIG. 26 is a screen shot of an example user interface of an example of a data integration system of the present invention that may be presented to a customer during a Save Recipient Profile step;

FIGS. 27A and 27B are screen shots of an example user interface of an example of a data integration system of the present invention that may be presented to a customer during a View Gift step;

FIG. 28 is a screen shot of an example user interface of an example of a data integration system of the present invention that may be presented to a customer during a View Merchant with Promotional Video Clip step;

FIG. 29 is a screen shot of an example user interface of an example of a data integration system of the present invention that may be presented to a customer during a Personalize Your Reply to Gifter step;

FIG. 30 is a screen shot of an example user interface of an example of a data integration system of the present invention that may be presented to a customer during a Recipient-generated Media Reply step;

FIG. 31 is a screen shot of an example user interface of an example of a data integration system of the present invention that may be presented to a customer during an Enter Text and/or Emoji Reply step;

FIG. 32 is a screen shot of an example user interface of an example of a data integration system of the present invention that may be presented to a customer during a Redeem Gift step;

FIG. 33 is a screen shot of an example user interface of an example of a data integration system of the present invention that may be presented to a customer during a first Exchange Merchant step;

FIG. 34 is a screen shot of an example user interface of an example of a data integration system of the present invention that may be presented to a customer during a Select New Merchant step;

FIG. 35 is a screen shot of an example user interface of an example of a data integration system of the present invention that may be presented to a customer to allow the customer to select a gift recipient and a merchant from a merchant marketplace;

FIG. 36 is a screen shot of an example user interface of an example of a data integration system of the present invention that may be presented to a customer to allow the customer to select a merchant from a merchant marketplace when exchanging an original merchant for a new merchant;

FIG. 37 is a screen shot of an example user interface of an example of a data integration system of the present invention that may be presented to a customer to allow the customer to preview and select a system video clips from a system video library during a recipient reply-to-gift process; and

FIG. 38 is a screen shot of an example user interface of an example of a data integration system of the present invention that may be presented to a customer to allow the customer to preview and select a system video clips from a system video library during a giver establish-gift process.

### DETAILED DESCRIPTION

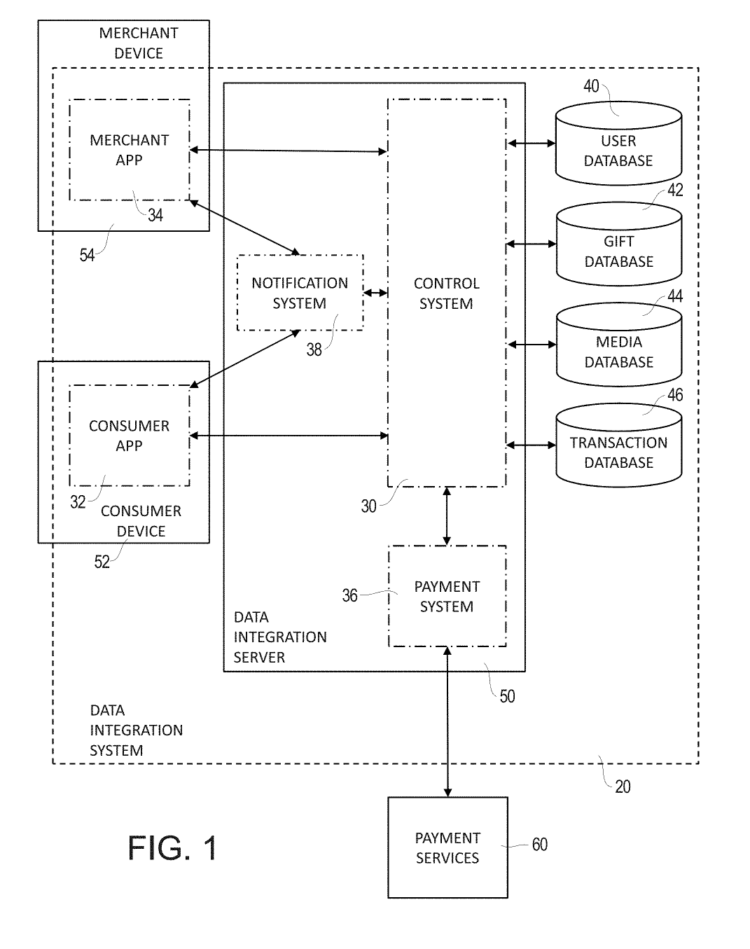

FIG. 1 of the drawing illustrates an example Data Integration System 20 constructed in accordance with, and embodying, the principles of the present invention. The example Data Integration System 20 comprises a control system 30, at least one Customer Application 32, at least one Merchant Application 34, a Payment System 36, and a Notification System 38. FIG. 1 illustrates that the example control system 30 is further operatively connected to a User Database 40, a Gift Database 42, a Media Database 44, and a Transaction Database 46.

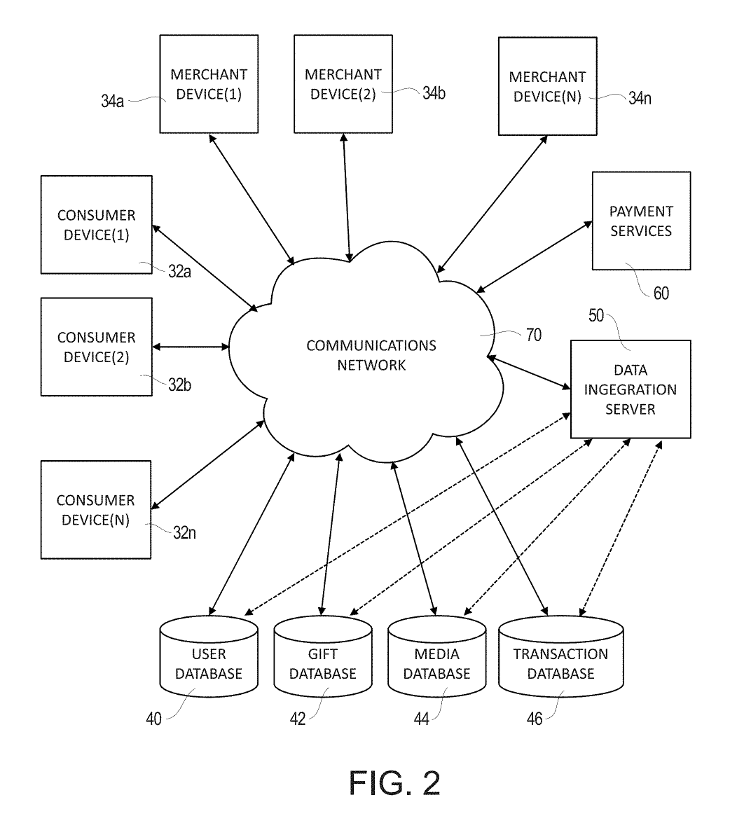

In the example depicted in FIG. 1, the example Data Integration System 20 is configured to run on a data integration server 50, at least one Customer Device 52, at least one Merchant Device 54. In particular, FIG. 1 illustrates the example control system 30 and the example Notification System 38 are configured to run on the data integration server 50, the example Customer Application 32 is configured to run on the Customer Device 52, and the example Merchant Application 34 is configured to run on the Merchant Device 52. The example Data Integration System 20 is further configured to take advantage of payment services 60 to facilitate payments. In the example configuration of the example Data Integration System 20 as depicted in FIG. 2, the example data integration server 40, a plurality of Customer Devices 52a-n, and a plurality of Merchant Devices 54a-n are operatively connected to a communications network 70 such as the Internet.

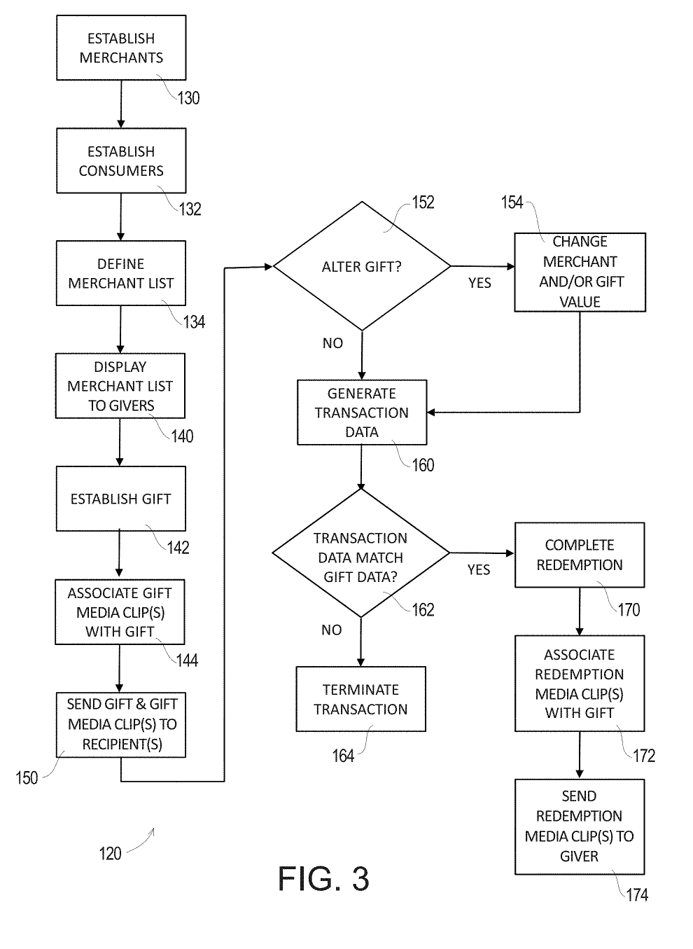

FIG. 3 illustrates an example of a Data Integration Process 120 that may be used by the example Data Integration System 20 of the present invention. Merchants are established at step 130 and Customers are established at step 132. In the following discussion, a Customer who establishes a Gift will be referred to herein as a Giver in the context of that particular Gift. Consumers may also be the Recipient of a Gift, in which case the Customer will be referred to as a Recipient in the context of that particular Gift. A Merchant who establishes a Gift may, in the context of that particular Gift, also be referred to as a Giver, but Merchant entities will typically not function as Recipients.

In the example Data Integration Process 120, at least one Merchant list is defined at step 134. Typically, the Merchant list will include Merchants sorted into marketing regions or by type of product or services offered.

At step 140, the Merchant list is made available for display to Customers. Consumers are allowed to establish a Gift at step 142 and associate the Gift with a Gift Media Clip(s) at step 144. Step 142 additionally allows Merchants to establish a Gift as well, and the Merchants can associate a Gift Media Clip(s) with the Gift at step 144. The Gift will be stored as Gift Data including a Gift ID uniquely associated with the Gift, at least one Gift Value (in currency), the user ID associated with the Giver as a Giver ID, the user ID of another Customer, referred to as the Recipient or Recipients, as a Recipient ID, at least one media ID, and at least one Merchant ID. A URL may be associated with the Media ID for Media Clips stored by services outside of the example Data Integration System 20.

Once the Gift has been established, the Gift Media Clip(s) associated with that Gift is made available for display to the Recipient at step 150.

The Recipient is next allowed to alter the Gift at step 152. If the Recipient elects to alter the Gift, the process 120 moves to step 154, where the Recipient may change an aspect of the Gift, such as the Merchant, by altering the Gift Data, such as the Merchant ID.

Once the Recipient is satisfied with any alterations the Gift, the Recipient may proceed to a redemption portion of the process 120 starting at step 160. When the Redemption Transaction is initiated, Transaction Data including a transaction ID is created. The Recipient is further prompted to optionally identify a Media Clip to be associated with the transaction, and the media ID associated with each Media Clip is stored as part of the Transaction Data. At step 160, the Recipient further confirms a redemption value and the name of the Merchant associated with the transaction, and the redemption value and the Merchant ID are stored as part of the Transaction Data.

The Redemption Transaction is validated at step 162. In particular, at step 162 the redemption value and the name of the Merchant ID of the Transaction Data associated with the Redemption Transaction are compared to the at least one Gift Value and Merchant ID of the Gift Data. If the Transaction Data meets certain parameters with respect to the Gift Data, the Transaction Data matches the Gift Data. If not, the transaction is terminated at step 164.

If the Transaction Data matches the Gift Data, the payment process is initiated at step 170 to pay the Merchant associated with the Redemption Transaction. The Recipient is then prompted at step 172 to optionally identify a Media Clip to be associated with the transaction, and the media ID associated with the Media Clip is identified at step 172 and is stored as part of the Transaction Data. Once the Redemption Transaction is complete, any transaction Media Clip associated with that Redemption Transaction is made available for display to the Giver at step 174.

As an alternative to the in-person Redemption Transaction described at steps 160 and 162, online Redemption Transactions can be performed. In this case, the Recipient clicks a Redeem Gift button on the Merchant's website (or a Redeem Online in the Customer Application), at which point the Recipient is directed to a Merchant Redeem Window (e.g. pop-up window, new web page, or new user-interface screen which includes an embedded Merchant ID, and is hosted on the Data Integration System 20). At that point, the Recipient is prompted to enter the exact dollar amount to redeem (not to exceed the Gift value), and the Recipient Information (e.g., phone number or email address) associated with the Recipient, and clicks “Enter” to submit the entered data. The Data Integration Process 120 checks the Merchant ID, the amount redeemed, and the Recipient's contact information to validate the Recipient's Gift stored in the Data Integration System 20. If the amount, Merchant ID, and Recipient Information submitted by the Recipient matches the corresponding details of Recipient's Gift in the Data Integration Process 20, the example Data Integration Process 120 confirms the Redemption Transaction and a “Confirmed” notice is displayed on the Customer Application and/or Merchant Redeem Window. If the amounts/values do not match, the Redemption Transaction is canceled and a “Denied” notice is displayed in the Customer Application and/or the Merchant Redeem Window.

In the example Data Integration Process 120 as depicted in FIG. 3, certain steps may be omitted or skipped under certain circumstances. For example, if the Giver is a Merchant, the Giver/Merchant will most likely only want to establish Gifts promoting the goods and/or services of that Giver/Merchant. In that case, the example process may not display to the Giver/Merchant a Merchant List but will instead bypass step 140. As another example, Givers of Gifts may skip step 144 and 174, while Recipients of Gifts may skip steps 150 and 172. Other steps may be performed in an order different from that depicted in FIG. 3. For example, the order of steps 130 and 132 may be reversed. Additionally, once a Merchant and/or Customer are established at steps 130 or 132, those steps 130 or 132 would typically not be presented to registered Merchants and Customers who subsequently use the example Data Integration Process 120. Also, the Recipient may elect to perform steps 172 and 174 immediately after the Gift is sent at Step 150 in addition or instead of waiting for the completion of the redemption process at step 170.

The example data integrated process 120 as implemented by the Data Integration System 20 as described herein facilitates the integration of data to allow multiple users to function as Givers and/or Recipients in the context of multiple Merchants.

Referring for a moment back to FIG. 1, dot-dash lines indicate software components, while solid lines indicate hardware. Even broken lines in FIG. 1 indicate logical groupings of software modules. While an example of a hardware configuration and various software components running on this hardware configuration is shown in FIG. 1, other configurations of hardware and software components may be used to implement the principles of the present invention.

The exact nature of the hardware used to host the example Data Integration System 20 depends on the particular combination of Customers, Merchants, and transactions accommodated by that system 20. As shown in FIG. 2, the Customer Application 32 is typically replicated on a plurality of Customer Devices 52a, 52c, through 52n. The Merchant Application 34 is similarly typically replicated on a plurality of Merchant Devices 54a, 54c, through 54n. The exact number of Customer Devices 52 and Merchant Devices 54 depends on the number of users and Merchants using the example Data Integration System 20. Further, although the example databases 40, 42, 44, and 36 are shown as separate from the data integration server 50 in FIG. 1, these databases 40, 42, 44, and 46 may be configured to run on the data integration server 50.

The example databases 40, 42, 44, and 46 may be web services available over the communications network 70 (as shown by solid lines in FIG. 2) and hosted by third parties. Alternatively, the example databases 40, 42, 44, and 46 may be directly connected to the data integration server 40 (as shown by broken lines in FIG. 2). The communications network 70 allows data to be exchanged between the various components of the example Data Integration System 20 and the databases 40, 42, 44, and 46 and between the various components of the example Data Integration System 20 and the payment services 60.

The example Data Integration Process 120 is implemented using the software components forming the Data Integration System 20. In particular, the software components interface with each other and with hardware and external services to implement the functionality of the Data Integration Process 120 as described herein. The Data Integration Process 120 is not necessarily sequential, and certain steps may be implemented in an order different from that represented in FIG. 3. Specific functions of the Data Integration Process 120 must be implemented on a particular hardware device (e.g., data input on the Customer Device), but other such functions (e.g., data integrity checks) may be handled by different hardware devices depending upon available hardware functionality, communications bandwidth, and the like. Further, an actual implementation of the present invention will likely involve additional steps and sub-steps to those of the example Data Integration Process depicted in FIG. 3.

With the foregoing general understanding of the principles of one example of the present invention in mind, details of the example Data Integration System 20 and example Data Integration Process 120 will now be described in further detail.

As indicated in FIG. 2 above, the example Data Integration System 20 will typically be configured to accommodate multiple Customers and multiple Merchants. Consumers are typically individuals, while Merchants may be individuals or business entities. In the interests of brevity, the term “Merchant” may be used herein to refer to individuals authorized by the Merchant entity to interface with the example Data Integration System 20 as described herein.

Each Customer will have access to a Customer Application 32, and each Merchant will have access to a Merchant Application 34. Typically, but not necessarily, the Customer Application 32 is a standalone application running on a portable computing device such as a smartphone, tablet, or the like. The Merchant Application 34 will typically, but not necessarily, be a standalone application running on a workstation, point of sale system, or the like. However, the Customer Application 32 may be configured to run on a fixed workstation or to be accessed using a browser application, and the Merchant Application 34 may be configured to run on a portable computing device or to be accessed using a browser.

Each Customer will establish a Customer Account with the example Data Integration System 20 that allows the Customer to access the system from multiple devices. Each Merchant will establish a Merchant Account with the example Data Integration System 20 that allows the Merchant to access the system from at least one device in the control of the Merchant.

To establish a Customer Account, the Customer will install, or access using a browser, the Customer Application 32 on at least one Customer Device 52 such as a smartphone and enter Customer Data such as name, email, phone, address, and Customer payment source (credit card token) data. The example Data Integration System 20 will validate the identity of the Customer and assign a Consumer ID unique to each Customer. The Consumer ID will be stored as part of the Customer Data. The validation process is typically performed by a web service provided by a third party based on the biographic and payment data. Conventional security methods such as password, biometric, or other may be used to authenticate Customers before allowing access to the Customer Account. The following detailed description of the operation of the example Data Integration System 20 assumes that each Customer has an existing Customer Account and a unique Consumer ID.

Additionally, the Customers may optionally be allowed to identify certain Merchants as favorite Merchants, and the Data Integration System 20 stores such Merchants in a Merchant wish list associated with the Customer Account. The Merchants may identify favorite Merchants by swiping through a list of available Merchants and identifying individual Merchants in the list as favorite Merchants. Further, the Merchant wish list may be sorted by Merchant parameters such as the geographical location and/or type of goods and/or services provided by the Merchant.

To establish a Merchant Account, the Merchant will install or establish a link to the Merchant Application 34 (e.g., using a browser) on at least one Merchant Device 54 such as a point of sale system. To set up the Merchant Account, the Merchant will enter Merchant Data comprising name, email, phone, address(es), description, Merchant Media, and Merchant payment destination (e.g., bank or PayPal account number) data. The Merchant ID will be stored as part of the Merchant Data. The example Data Integration System 20 will validate the identity of the Merchant and assign a Merchant ID unique to each Merchant. The validation process is typically performed by a web service provided by a third party based on the Merchant details, location, and banking data. Conventional security methods such as password, biometric, or other may be used to authenticate individuals accessing the Merchant Account. The following detailed description of the operation of the example Data Integration System 20 assumes that each Merchant has an existing Merchant Account and a unique Merchant ID.

The Customer Devices 52 may include one or more location services such as the global positioning system (GPS). The Customer may configure the location services to allow the Data Integration System 20 and/or Customer Application 32 to have access to the real-time location of the Customers using the portable Customer Devices 52. Certain steps of the example Data Integration System 20 as described in detail below may be implemented only if the example Data Integration System 20 and/or Customer Application 32 has access to the real-time locations of the Customers.

The Customers and Merchants can both function as a Giver to initiate a Gift Process. In particular, using the Gift Process the Giver creates a Gift by identifying one or more Recipients, at least one Gift Value, and a Merchant associated with that particular Gift.

When selecting the Merchant, the Giver may identify any Merchant registered with the Data Integration System 20. However, the list of Merchants may be filtered and/or sorted by any one of a number of Merchant parameters. Merchants may be filtered by geographical location, nature or type of goods or services provided, and/or by a Customer rating system. If the Recipient is a registered Customer, the Data Integration System 20 may also be configured to allow the Giver to view, filter, and/or sort any preferred Merchant list set up for that Recipient. The Giver may optionally select a Merchant from the preferred Merchant list.

Optionally, the Gift Process may include one or more Delivery Conditions that allow the Giver to determine when and how the Gift is sent to the Recipient(s). As one example, the Delivery Conditions may include setting a day and time in a calendar. The example Data Integration System 20 is configured to send a Gift Notification to the Recipient on the day and time set during the Gift Process. As another example, the Delivery Conditions may be set to trigger the Gift Notification based on the actual location of the Recipient. In this case, the Data Integration System will generate the Gift Notification when the Recipient is within a predetermined distance of the Merchant associated with the Gift.

At the time the Gift Process is initiated, the Recipient may or may not be a registered Customer of the example Data Integration System 20. If the Recipient is not a registered user, the Recipient may be identified by a unique piece of information (e.g., email address) such that the Recipient may be notified that a Gift has been created naming them as the Recipient. A non-registered Recipient must install a copy of the Customer Application 32 to access the functionality of the example Data Integration System 20 and redeem the Gift.

Similarly, if the Giver would like to select a Merchant not already registered with the Data Integration System 20, the Data Integration System 20 may be configured to allow the Giver to identify that unregistered Merchant. The Data Integration System 20 may then notify the unregistered Merchant that a (typically unnamed) Giver would like to give a Gift identifying the unregistered Merchant and allow the previously unregistered Merchant to register. After the Merchant has registered, the Merchant ID associated with that newly registered Merchant may be included in the Gift Data. The process of finalizing the Gift will be delayed until the newly registered Merchant has completed the registration process.

The example Data Integration System 20 assigns a unique Gift ID for each Gift. In addition, the example Data Integration System 20 will assemble Gift Data including, in addition to the Gift ID, the at least one Gift Value, a Giver ID, a Recipient ID, a Merchant ID. The Giver ID may be the Consumer ID or Merchant ID associated with the Giver, the Recipient ID may be the Consumer ID associated with the Recipient (when available), and the Merchant ID of the Merchant identified by the Giver. Alternatively, the Giver ID and Recipient ID may be generated at the time each unique Gift is created, in which case the Giver ID is linked to the Consumer ID or Merchant ID of the Giver and the Recipient ID is linked to the Consumer ID of the Recipient. If the Recipient does not have a Consumer ID at the time the Gift is created, the Gift Data will include placeholder data (e.g. email address) until the Recipient creates a Consumer ID, at which point the newly created Consumer ID of the Recipient is stored as part of the Gift Data. The Gift Data will further comprise the Merchant ID of the Merchant designated by the Giver.

At the time the Gift is established, the Giver is prompted to include a Media Clip as part of the Gift Data. The term “Media Clip” as defined herein is to include text, images, animations, audio, video, and combinations thereof. The Customer Application 32 allows Customers to enter a Media Clip into the example Data Integration System 20, select a preconfigured video clip stored by the Data Integration System 20, and select a video clip previously entered into the Data Integration System 20 by the Merchant associated with the Gift. Each Media Clip is stored as media data, and a Media ID is assigned to the media data associated with each Media Clip. The Gift Data typically, but not necessarily, includes at least one Media ID associated with the Media Clip selected by the Giver.

Ideally, the Giver will select several Media Clips when establishing a Gift. The Giver will select a personalized Media Clip generated by the Giver and a standardized Media Clip generated by the Merchant associated with the Gift. The Media ID associated with each such Media Clip is stored as part of the Gift Data for each Gift. In this case, the Gift Data will include multiple Media IDs. Again, any Media Clip generated by the Giver may be customized for a particular Recipient, occasion, or sentiment.

Preconfigured Media Clips made available by the Data Integration System 20 may be stock images, animations, audio, video, and combinations thereof created for different types of sentiments, occasions, Recipients, and the like. For example, the Data Integration System 20 may make available to the Gifter preconfigured Media Clips associated with the Recipient (e.g., Recipient name), occasions (e.g., birthdays, graduations, retirements), or sentiment (e.g., gratitude). The Data Integration System 20 may thus allow the Giver to customize the preconfigured Media Clips by, for example, adding text such as a phrase and/or name associated with the Gift. The operator of the Data Integration System 20 may elect to charge a fee for selecting and/or customizing preconfigured Media Clips.

When the Gift is finalized, the Data Integration System 20 charges the at least one Gift Value to the payment method set up by the Customer. The currency amount of the at least one Gift Value is transferred from the Giver's account (e.g., bank, credit card, or PayPal account) to an escrow account (typically, bank account) maintained by the operator of the Data Integration System 20. In addition, the operator of the Data Integration System 20 has the option of charging a fee for setting up the Gift, and that fee may be transferred from the Giver's account to an operating account owned by the operator of the Data Integration System 20 for services rendered at the same time that the at least one Gift Value has been transferred to the escrow account.

After the Gift has been established, the Data Integration System 20 instructs the Notification System 38 to send a Gift Notification notifying the Recipient that a Gift has been established to their benefit. The notification may be directly through the Customer Application 32 associated with the Recipient and/or by separate means such as email. The Data Integration System 20 includes the new Gift in a Customer Pending Gift List forming a part of or accessible by the Customer Application 32. And as described above, the timing of the Gift Notification may be determined by Gift Conditions.

Any Giver, whether it be a Customer or a Merchant, can identify a plurality (two or more) Customers as Recipients by establishing a Recipient Group Gift. In this case, multiple Recipient IDs are included in the Gift Data. The Gift may establish a total Gift Value to be spent by the group as a whole or individual Gift Values associated with individual Customers in the group.

In addition, groups of Givers, including Customers and/or Merchants, may establish a Giver Group Gift in which one or more Customers are identified as Givers by establishing a Giver Group Gift. In this case, multiple Giver IDs are included in the Gift Data. The Gift Data may further include at least one, and potentially a plurality of, Recipient IDs. The Gift may establish a total Gift Value to be spent by the group as a whole or individual Gift Values associated with individual Customers in the group.

For Customers, the ability to list multiple Recipients allows Recipient Group Gifts to be established naming groups of individuals. Typically, but not necessarily, individuals in such Customer established Recipient Group Gifts will have a preexisting relationship with each other. Siblings, members of a wedding party, coworkers, and team members are examples of groups of individuals who may be included as co-Recipients of a Customer established Group Gift. The ability to group together Givers allows multiple Givers, such as members of a team, to establish a Giver Group Gift in the name of a coach or group of coaches.

For Merchants, the ability to establish a Gift in the name of either one or a plurality of Customers can be a useful promotional tool. Any registered Customer or group of Customers may be identified as part of a Merchant established Gift. Typically, the Merchant will filter and/or sort Customers based on at least one Customer parameter such as address, previous relationship with the Merchant, and GPS location. For example, the Merchant established Group Gift may name all Customers within a predetermined geographical area who have purchased goods or services from the Merchant within the last six months. In addition, the Merchant may establish a Gift for a group of Customers based on a one-time or recurring event (e.g., business anniversary, holiday, festival) or periodically (e.g., weekly, monthly). Typically, but not necessarily, Customers of a Merchant established Group Gift would not have a preexisting relationship. When a Merchant establishes a Group Gift for Customers without a preexisting relationship, the Group Gift will typically, but not necessarily, assign a Gift Value for each Customer in the list. It is also possible for a Merchant to establish a Gift for a particular Customer outside of the context of a Group Gift. Any Merchant established Gift may include Gift conditions such as the Gift being conditional on a purchase by the Recipient of a certain amount and/or the Gift being redeemed within a predetermined period of time.

When the Gift has been established, the Data Integration System 20 instructs the Notification System 38 to send a Gift Notification notifying the Merchant that a Gift has been established in which the Merchant has been named. The Gift Notification may be directly through the Merchant Application 34 associated with the Recipient and/or by separate means such as email. The Data Integration System 20 includes the new Gift in a Merchant Pending Gift List forming a part of or accessible by the Merchant Application 34.

When the Data Integration System 20 notifies the Recipient of the Gift, the Recipient is prompted to view any Media Clips associated with that Gift. In particular, the Customer Application 32 is able to access any Media Clip associated with the Gift based on one or more Media IDs in the Gift Data associated with that Gift. The Recipient is thus able to use the Customer Application 32 associated therewith to view a personalized Media Clip uploaded by the Giver and/or a Media Clip of the Merchant. The Media Clip may also be a stock Media Clip made selected from a System Media Library maintained by the Data Integration System 20.

At this point, the Data Integration System 20 allows the Recipient Customer to alter the parameters of the Gift. The alterable parameters of the Gift include, as examples, the at least one Gift Value and the Merchant. Accordingly, for any Gift in the Customer Pending Gift List, the Recipient may be given the option to change the Gift Value(s) and/or the Merchant associated with that Gift. The Gift Data may track the original Gift Value and any such increase in Gift Value separately. The Gift Data at any time will thus reflect any changes. If a new Merchant is substituted for a previous Merchant, the Data Integration System 20 will update the Customer Pending Gift List and the Merchant Pending Gift List associated with both the original Merchant and the new Merchant of the change of Merchant in the Gift. Further, the Data Integration System 20 may cause the Notification System 38 to send a notification to the Giver and/or Merchant(s) associated with the Gift of the change of Gift parameters. If changes are made to the Gift parameters, the Data Integration System 20 will update the Customer Pending Gift List and the Merchant Pending Gift List with the new Gift parameters.

If the Recipient changes the Gift by increasing the Gift Value, the currency amount of the increase of the Gift Value is transferred from the Recipient's account (e.g., bank, credit card, or PayPal account) to an escrow account (typically, bank account) maintained by the operator of the Data Integration System 20.

After receiving the Gift Notification, the Recipient may redeem the Gift whenever desired. To initiate the Redemption Transaction, the Recipient negotiates a sales transaction with the current Merchant associated with the Gift. Once the total price of the sales transaction has been established, the Recipient enters or selects the name of the Merchant and enters the amount of the sales transaction into the Data Integration System 20 through the Customer Application 32 running on the Recipient's Customer Device 52. The Recipient then interacts with the Customer Application 32 to initiate the Redemption Transaction. The Merchant ID associated with the Merchant identified by the Recipient and the sale amount are then transmitted as Recipient Transaction Data to the Data Integration System 20. The Transaction ID is created when the first phase of the Redemption Transaction has been completed.

Once the Recipient has completed the first phase of the Redemption Transaction, the Merchant enters the sale amount into the Data Integration System 20 using the Merchant Application 34. The Merchant ID associated with that Merchant is transmitted along with the sales amount as Merchant Transaction Data to the Data Integration System 20. The Data Integration System 20 may send a Redemption Notification to the Merchant through the Merchant Application 34 on the Merchant Device 54 to prompt the Merchant to complete the Redemption Transaction.

The Data Integration System 20 then validates the Redemption Transaction by comparing the Recipient Transaction Data (e.g., sales value and Merchant ID) transmitted by the Recipient with the Merchant Transaction Data (e.g., sales value and Merchant ID) transmitted by the Merchant. If the Merchant ID and sales value of the Recipient Transaction Data matches the Merchant ID and sales value of the Merchant Transaction Data, the Redemption Transaction is validated. If one or both of the Merchant ID and sales value of the Recipient Transaction Data does not the corresponding the Merchant ID and sales value of the Merchant Transaction Data, the Redemption Transaction is denied, and a Transaction Denied Notice is sent to one or both of the Recipient and the Merchant.

When the Redemption Transaction has been validated, the Data Integration System 20 reduces the at least one Gift Value by the amount of the sales value. If the at least one Gift Value exceeds the sales value, the Gift persists, and the new Gift Value is the prior Gift Value less the sales value. If the Gift Value equals the sales value, the Gift Value is zero, and the Gift is closed. If the Gift Value is less than the sales value, the Gift Value is zero, the Gift is closed, and the Recipient will deal directly with the Merchant to make up the difference between the Gift Value and the sales value. Of course, the Recipient may increase the Gift Value prior to the Redemption Transaction to ensure that the Gift Value is sufficient to pay the sales value associated with the sales transaction.

After the amount of the sales value has been subtracted from the Gift Value, a payment is made from the escrow account maintained by the operator of the Data Integration System 20 to the payment destination identified by in the Merchant Data. Multiple banks and/or banking services may be involved in the Merchant Payment Process, and the Merchant Payment Process typically does not occur immediately. The Data Integration System 20 removes any redeemed Gifts from the Customer Pending Gift List and the Merchant Pending Gift Lists associated with the redeemed Gift. At this point, the Redemption Transaction is complete.

Upon completion of the Redemption Transaction, the Data Integration System 20 prompts the Recipient to initiate an acknowledgment process in which the Recipient identifies a Media Clip to be included as part of the Recipient Transaction Data. As noted above, the Customer Application 32 allows Customers to enter a Media Clip into the example Data Integration System 20, select a preconfigured video clip stored by the Data Integration System 20, or select a video clip previously entered into the Data Integration System 20 by the Merchant associated with the Gift. The Recipient Transaction Data thus typically, but not necessarily, includes at least one Media ID associated with the Media Clip selected by the Recipient. A URL may be associated with the Media ID for Media Clips stored by services outside of the example Data Integration System 20.

Ideally, the Recipient will select/upload at least one Media Clip associated with the redemption of the Gift. For example, if the Merchant associated with the Gift is a restaurant, the Recipient may enter a photographic image or video clip taken at the restaurant as a new Media Clip. The Data Integration System 20 assigns a Media ID to and stores the new Media Clip. The Media ID associated with each such Media Clip is stored as part of the Recipient Transaction Data for each Gift redemption. The Recipient Transaction Data may include multiple Media IDs.

When the Gift has been redeemed, the Data Integration System 20 instructs the Notification System 38 to send a Redemption Notification to the Giver that a Gift has been redeemed. The Redemption Notification may be directly through the Customer Application 34 associated with the Giver and/or by separate means such as email.

When the Data Integration System 20 notifies the Giver that the Gift has been redeemed, the Recipient is prompted to view any Media Clips associated with that Redemption Transaction. Media clips associated with the Redemption Transaction may be referred to as Reply Media Clips. The Reply Media Clip(s) may a personalized Media Clip uploaded by the Recipient, a Media Clip selected by the Recipient from the Merchant, a preconfigured stock Media Clip selected by the Recipient from a System Media Library, and/or a stock Media Clip selected and customized by the Recipient. More specifically, the Customer Application 32 and Customer Device 52 may access any Media Clip associated with the Redemption Transaction based on one or more Media IDs in the Transaction Data associated with that Redemption Transaction.

The Data Integration System 20 may be configured to track Customer parameters, Customer activity, Merchant parameters, Merchant activity, Gifts, Redemption Transactions, and/or feedback. Data related to past Gifts, pending Gifts, exchanged Gifts (changed Merchants), and/or redeemed Gifts can be used to predict, within reasonable statistical uncertainty, the likelihood of success of potential future relationships between Customers and Merchants. For example, based on data associated with Customer previous activity and current locations, the Data Integration System may inform a nearby Merchant who sells coffee that the Customer is likely to want coffee in the next few minutes. The Merchant may then establish a conditional Gift in the name of that particular Customer that expires in one hour. The operator of the Data Integration System 20 may charge Merchants a fee for the use of such data analytics and related services to enhance Customer/Merchant interaction.

Further, the Data Integration System 20 may allow a registered Merchant to use Giver and Recipient Media Clips in the Merchant's social media accounts. For example, if a Recipient creates a Media Clip in the form of sound and video showing the Recipient and friends enjoying a meal at a restaurant while redeeming a Gift, the Merchant may, with appropriate permission from the Recipient, post that Media Clip to the Merchant's Facebook account. The Data Integration System 20 may thus optionally include a social media system for facilitating, and perhaps automating, the process of posting Customer videos to Merchant social media accounts.

The example databases 40, 42, 44, and 46 will now be described in further detail. The example User Database 40 is configured to store the Customer Data and the Merchant Data. The example Gift Database 42 is configured to store the Gift Data corresponding Gifts created by users or Merchants. The example Media Database is configured to store the media data corresponding to Media Clips uploaded by the Customers and Merchants and any preconfigured Media Clips provided by the operator of the Data Integration System 20. The example Transaction Database 46 is configured to store the Transaction Data associated with the establishment, exchange, and redemption of Gifts. The Transaction Database 46 supports the transmission of data with the Merchant Application 34 and banking information with the payment services 60 through the Payment System 36.

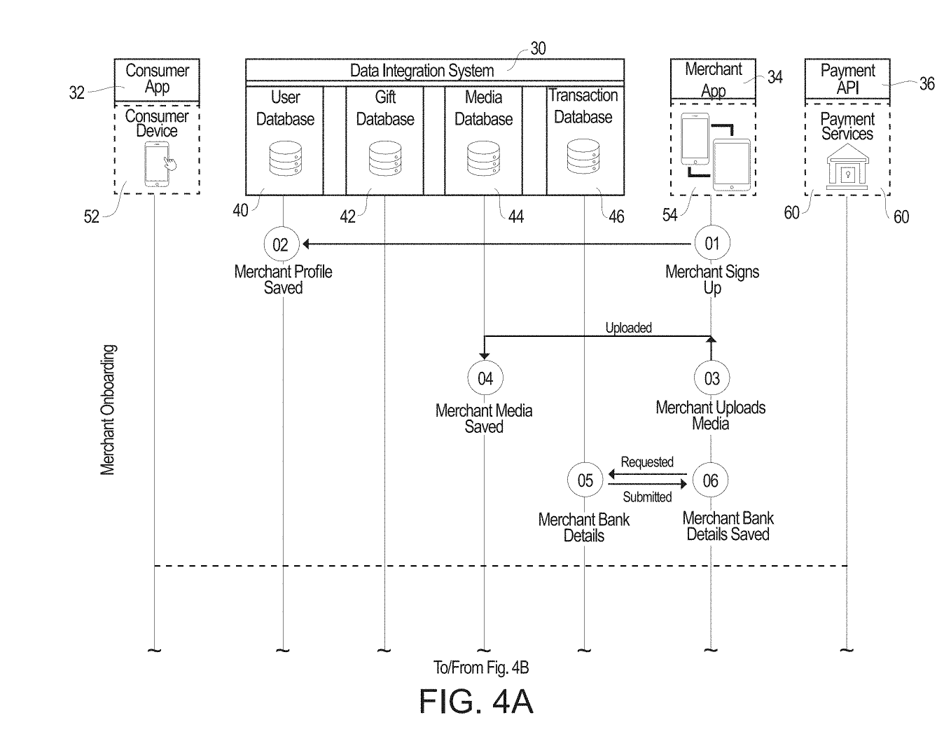

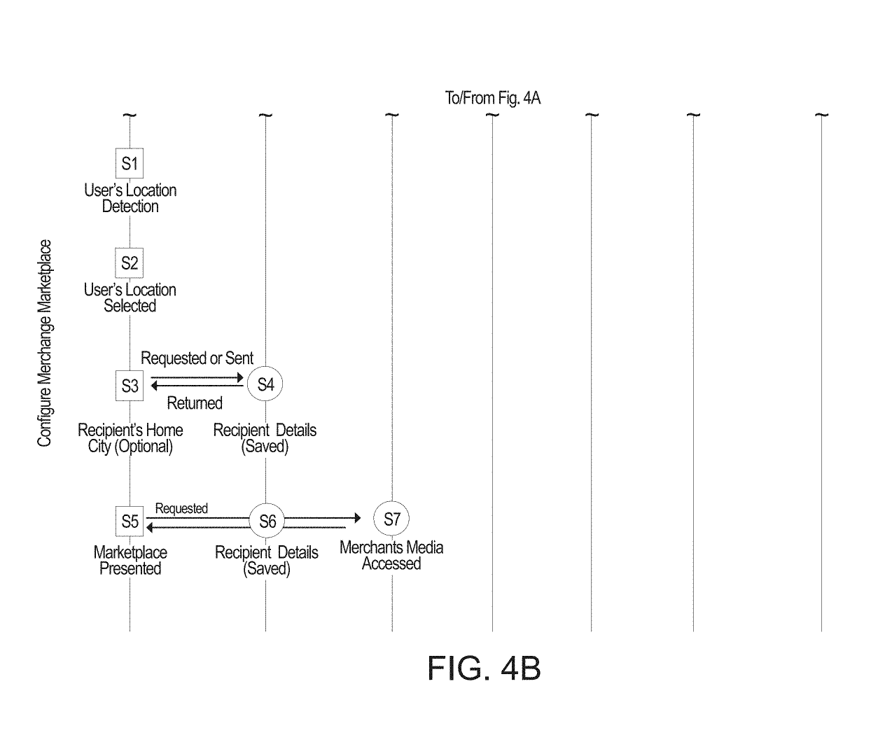

Referring now to FIGS. 4-10 of the drawing, a detailed example of a process that may be used to implement the example Data Integration System 20 will now be described. FIGS. 4-10 visually represent the interactions among the various components based on various input to the example Data Integration System 20. In particular, situations where the Customer Application 32 present information to and/or receive input from Customers and Merchants are depicted by squares in FIGS. 4-10, while method steps implemented by the example Data Integration System that do not involve the Customer Application user interface are represented by circles in FIGS. 4-10.

The example Data Integration System 20 implemented as shown in FIGS. 4-11 is a distributed system defining multiple data inputs and outputs (e.g., Customers, Merchants, payment services 60) and comprises multiple software and hardware systems that are typically connected by the communications network 70 as shown in FIG. 2. Also as shown in FIG. 2, the example Data Integration System 20 supports multiple users in the form of Customers each having access to at least one Customer Device 52 and multiple Merchants each having access to at least one Merchant Device 54. In this context, the example Data Integration System 20 accepts inputs and generates outputs for multiple sources simultaneously. Once at least one Customer Account has been created, the Data Integration System 20 as depicted in FIGS. 4-11 can operate, and the discussion of FIGS. 4-11 below assume that Customer Data associated with one or more Customer Accounts is stored in the User Database as generally described above.

Additionally, the discussion of the example Data Integration System 20 in FIGS. 4-11 assume that the Payment System 36 is configured to exchange data with the payment services system 60. The Customer and Merchant Data will contain the Customer and Merchant banking information necessary for the Payment System 36 to interface with the payment services system 60 to allow the Data Integration System 20 to accept payments from and make payments to Customer and Merchant payment sources such as credit card accounts, bank accounts, PayPal accounts, or the like.

When the User Database 40 contains at least Customer Data, the Data Integration System 20 simultaneously accepts multiple inputs from multiple sources. The functions described with respect to FIGS. 4-11 can operate independently of each other. Within each function, the logic flows somewhat sequentially, but at least some of the steps in the logic flows associated with at least some of these functions may be omitted in some implementations of the present invention and/or may be skipped in the detailed example of the present invention depicted in FIGS. 4-11.

Referring now to FIGS. 4A and 4B of the drawing, depicted therein is an example Marketplace Configuration Process. FIG. 4A depicts a Merchant onboarding portion of the marketplace configuration function, while FIG. 4B depicts the configuration of the Merchant marketplace by Customers.

Referring initially to FIG. 4A, at a Merchant Sign Up step O1, an individual Merchant signs up/registers with the example Data Integration System 20 by creating Merchant Profile comprising Merchant Data. Merchant onboarding example depicted in FIG. 4A, the Merchant Data may be compromised of contact, business, offer and/or promotion details. At a Merchant Profile Save step O2, the Merchant Data is saved to the User Database 40.

At a Merchant Uploads Media step O3, the Merchant uploads and/or edits Media Clips associated with the Merchant. The Media Clips can be identified as Recipient-facing (e.g., Merchant videos) and/or Giver-facing (e.g., promotional videos). At a Merchant Media Save step O4, the Merchant media is saved to the Media Database 44.

In the Merchant onboarding example depicted in FIG. 4A, the Merchant next submits banking information to the payment services system 60 (e.g., ACH Gateway) using the Payment System 36 (e.g., ACH API) at a Merchant Bank Details step O5. At a Merchant Bank Details Save step O6, the Merchant banking data is saved to the ACH Gateway.

The Merchant onboarding portion of the marketplace configuration function is typically populated by hundreds or thousands of Merchants to provide Customers with multiple choices for configuring the marketplace.

Referring now to FIG. 4B, an example of the Marketplace Configuration Process that may be performed by Consumers registered with the example Data Integration System 20.

At a Customer's Location Detected step 51, the present location of the Customer is identified, assuming that the Customer has authorized location services for the Customer Application 32 running on that Customer's Customer Device 52. In particular, if Location Services are enabled for both the Customer Device 52 and the Customer Application 34, geo-location is used to identify to the Customer's current physical location, and the Customer's current physical location is used as the Home City for purposes of configuring the Merchant market place for that Customer. If enabled, Location Services are prioritized over a previously saved Customer address.

At a Customer's Location Selected step S2, if Location Services are not enabled the app presents the Customer's address of record as the default Home City. Alternatively, the Customer may be prompted to enter or select a Home City for use by the Customer Application 32.

At an optional Recipient's Location step S3, the Customer may select a Recipient. If that Recipient's location is already known by the Customer Application (either by entered address or by geo-location), the Recipient's location is used as the Home Address. At a Recipient Details step S4, the system will Save and/or Return the Recipient's Home City for use in configuring the Merchant marketplace.

At a Marketplace Presented step S5, the Customer Application 32 presents the Customer with a relevant marketplace matching the Home City that has been Detected, Selected, or pre-Defined Home City for either the Giver or a potential Recipient. The marketplace is comprised of eligible Merchants, by business categories, Gifting occasions, or other categories. Eligible Merchants are defined as being active Merchants with retail locations that are located within the Detected, Selected or pre-Defined Home City.

For any Merchant of interest in the Merchant marketplace, the Merchant's details may be accessed at a Merchants' Details Accessed step S6, and the Merchant's previously entered Media Clips may be accessed at a Merchants' Media Accessed step S7.

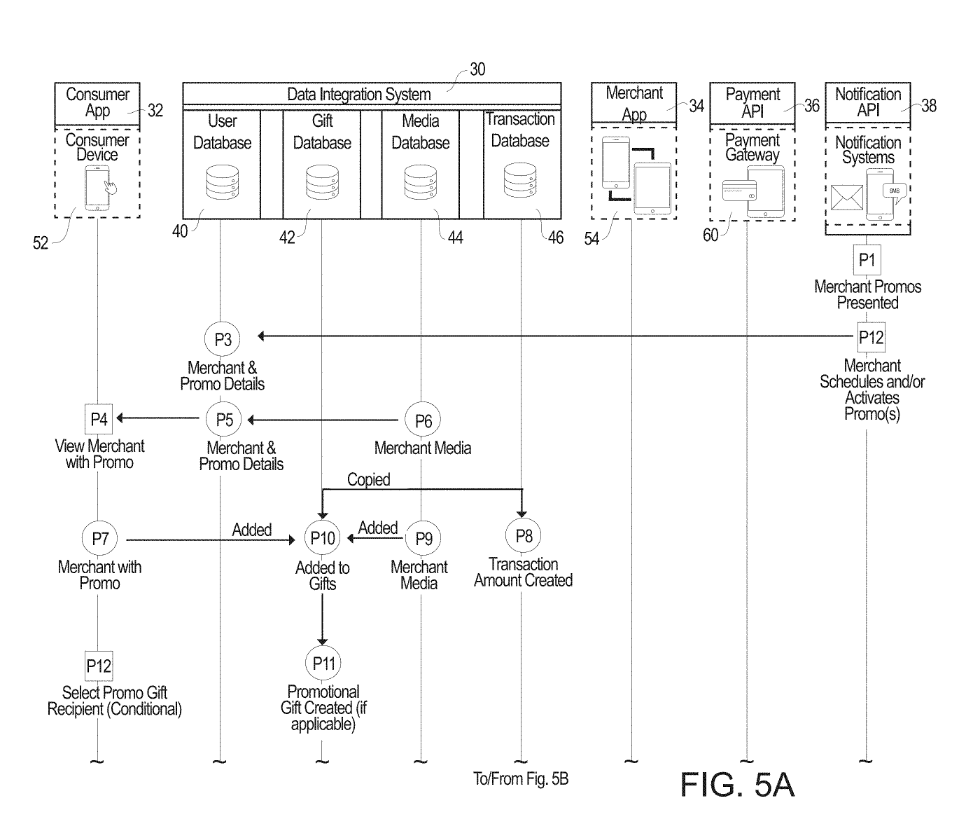

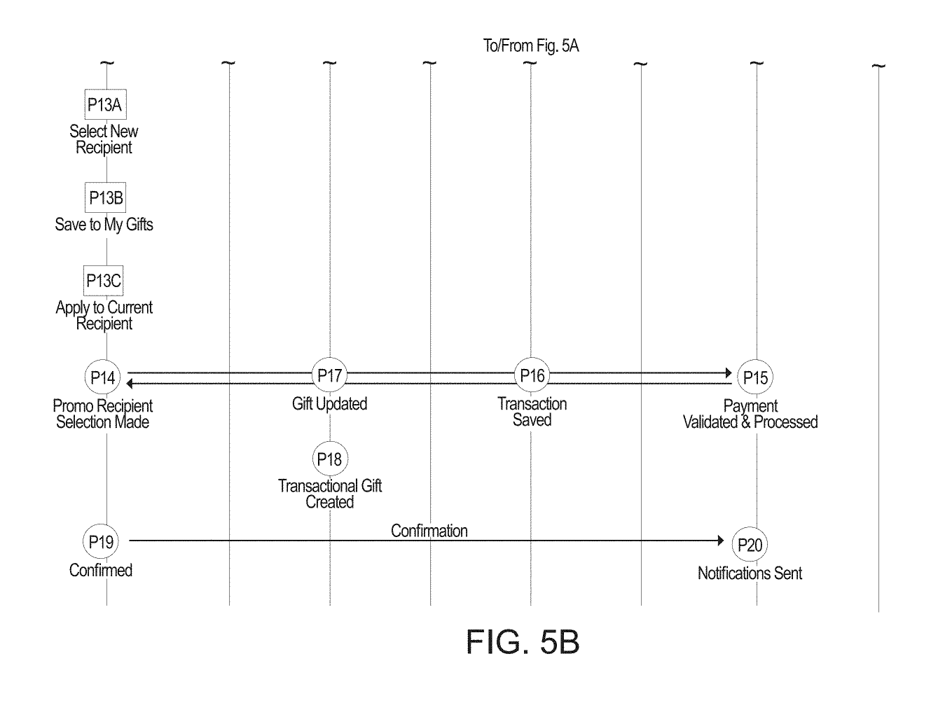

The example Data Integration System 20 as implemented in FIGS. 4-11 also supports preconfigured Merchant promotional programs. FIGS. 5A and 5B illustrates an example Promotional Program Selection Process by which Merchants may establish Gifts using a set of standardized promotional tools such as “Buy One, Get One” (BOGO) and “By One, Give Two”.

At a Merchant Promos Presented step P1, the Merchant logs into Merchant Application 34 and accesses the available preconfigured promotional program options. Each preconfigured promotional program is assigned a Promo ID. At a Merchant Schedules and/or Activates Promo(s) step P2, the Merchant has the option of activating one or more preconfigured promotional programs or modifying one or more selected preconfigured promotional programs by, for example, scheduling the duration of the promotion by defining an end date of the selected preconfigured promotional program. At a Save Merchant & Promo Details step P3, the Merchant Data and data representing the Promo ID, including any default or modified parameters of the preconfigured promotional program, are saved to the User Database 40. At a View Merchant (w/Promo) step P4, a Customer may select and view, from the Merchants or a Merchant marketplace, a Merchant Profile (Details Page) and, when active, that Merchant's available promotional programs. The details of promotional programs associated with the selected Merchant are retrieved from the User Database and presented to the requesting Customer. At a Merchant Media step P6, any Media Clips associated with the promotional programs will be presented to the requesting Customer.

At a Merchant (w/Promo) & Amount Chosen step P7, the Giver initiates the Gift Process by selecting a Merchant and an active Merchant promotional program and setting a Gift Value associated with that Gift. At a Transaction Amount Created step P8, a Gift ID is created, and Gift Data including the Gift Value and the Gift ID is stored in the Transaction Database. The Gift Data is subsequently copied to the Gift Database 42 upon purchase. At a Merchant Media step P9, Merchant components, such as Merchant ID and, optionally, at least one Media ID, are added to the Gift Data upon completion of the purchase of the Gift.

At an Added to Gift step P10, the Promo ID associated with the Merchants Gift offer and any associated active promotional programs, along with up-to-date store location and Media Clips, to be presented with the Gift are retrieved and added to the Gift Data, and the Gift Data is stored in the Gift Database 42. At a Promotional Gift Creation step P11, the Promo ID for the Merchants Gift offer and the active promotional programs are attached to the to allow for up-to-date store location and videos to be presented with the Gift.

At a conditional Select Promo Gift Recipient step P12, the Customer is presented with three options related to the promotion related Gift if allowed by the parameters of the Merchant defined promotion. The first option is whether to select the Recipient of the promotional program related Gift at a Select New Recipient step P13a. If the Customer selects this option, the Customer is directed to first complete their original transaction, after which they will have the opportunity to Create/Add or Select the NEW, i.e. OTHER Recipient who will receive the promotional program related Gift.

If the Customer elects a Save to My Gifts step P13b, the promotional program related Gift will be saved and included in the Giver's My Gifts list.

If the Customer selects an Apply to Current Recipient at step P13c, the Promo Gift Value will be applied so as to increase the total value of the Gift being sent to the current Recipient.

Upon selecting a Promo Recipient at a Promo Recipient Selection Made step P14, a validation of the Credit Card occurs with the payment gateway. If the card is validated the Gift is established, scheduled or group invitations are sent depending on the Send choice. If not, the Giver is instructed to utilize another credit card.

Once the credit card is validated at a Payment Validated & Processed P15, the Gift amount is posted to the Transaction Database with the unique Gift ID.

Once the credit card is validated the amount is fed from the Transaction Database to the Gift Database 42 to populate the Gift Data associated with the Recipient's Gift, the other components held in temporary memory are now added to the Gift Data, stored in the Gift Database 42, and a Gift notification is sent at a Transaction Saved step P16.

Once the credit card is validated, the Giver sees a “Sent” confirmation if sent immediately at a Gift Updated step P17. If the Gift has been scheduled, the Giver sees a “Scheduled” confirmation. If the Gift is a Group Gift, the Giver sees a “Notifications Sent” confirmation. Once the Gift is sent (regardless of date), notifications via text and email (if both were entered) are sent to the Gift Recipient as described in the Gift Receive schematic.

When applicable, a discrete Promotional Gift is created at a Promotional Gift Created step P18. At this step, Gift (and promo) details are saved in the Gift Database 42.

At a Confirmed step P19, the example Data Integration System 20 sends messages via an API defined by the Notification System 38 to external email and SMS notification systems to send a notification of the Gift to the Recipient(s) named in the Gift. If the Recipient is already enrolled in the example Data Integration System 20, the Data Integration System 20 will send a Gift notification.

If the Gift notification is sent immediately, upon the “Sent” confirmation, the Giver is directed to a screen providing the ability to post Gift details to their account in one of several Social Media outlets at a Notifications Sent step P20. If the Giver chooses to post to a Social Media account, they are instructed to login to the Social Media account, and the Gift Post is started for them. They can then edit the Gift Post and post as normal through that Social Media account. Alternatively, the Giver can choose to make the Gift private. If the Gift is Scheduled or a Group Gift is given, the Giver is returned to the home screen of the Customer Application 32.

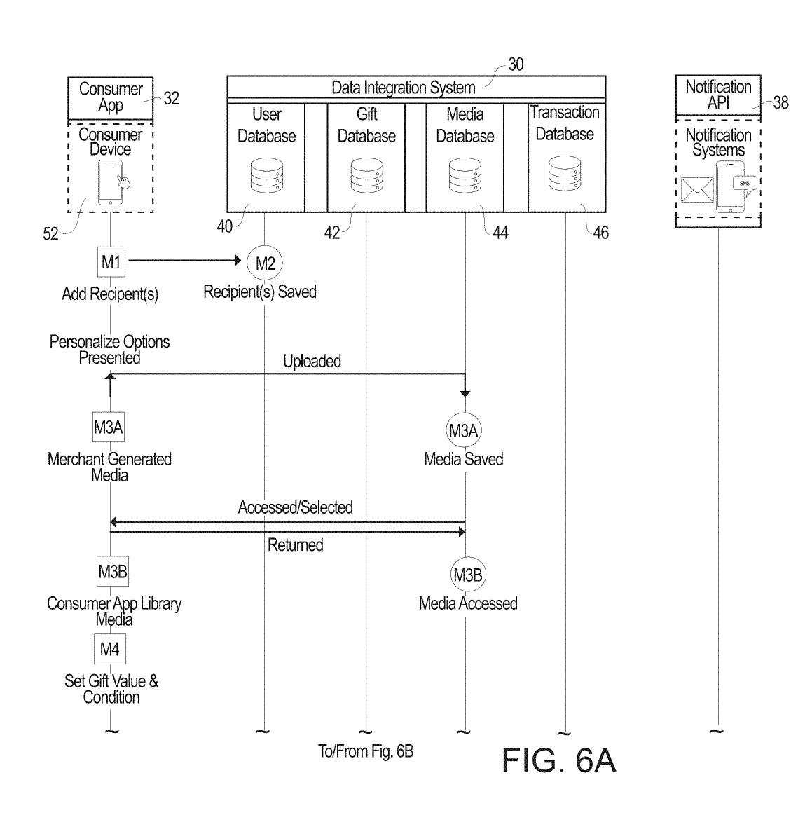

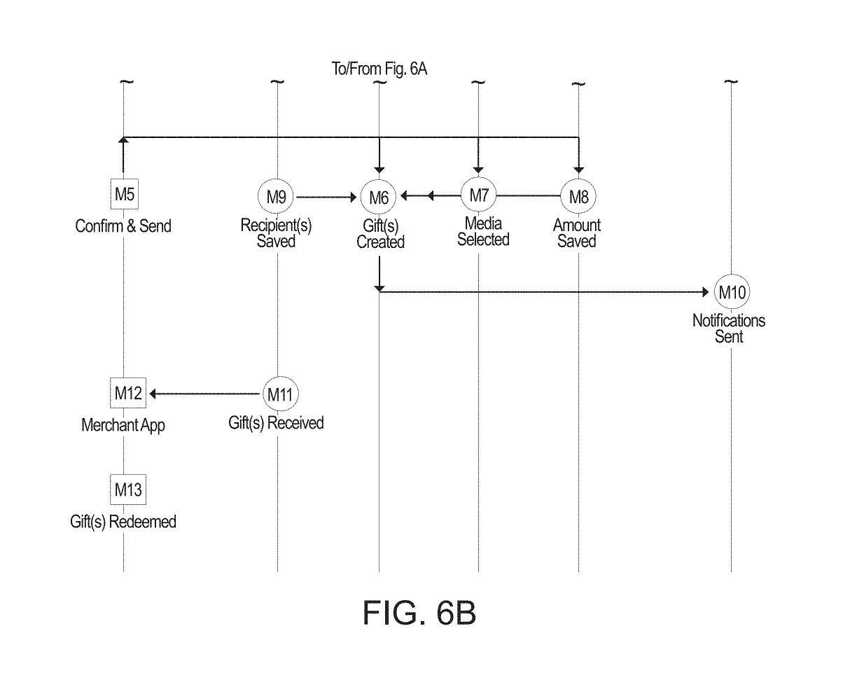

Turning now to FIGS. 6A and 6B, an example Merchant Gift Build Process will now be described.

At a step M1, the Merchant adds one or more Recipients via the merchant application 34. Merchant created Gifts can be one to one or one to many. The Merchant can key or upload Recipient(s) name, email address, mobile number (one or the other—both are preferable) and city and State (optional).

At step M2, the Recipient(s) are temporarily saved to the User Database 40. These will be permanently saved once the Gift(s) is(are) sent. If the Gift(s) is(are) not sent, or if Recipients are deleted, the example Data Integration System 20 will not store the information.

At a step M3, the Merchant is then presented with personalization options. The Merchant can either create a Media Clip (e.g., video, still) via the user interface of the merchant application 34 or may use Media Clips from Merchant Device 54. If the Merchant use its own Media Clips, the Media Clip is saved to the Media Database 44. Alternatively, the Merchant can select preconfigured Media Clips from the System Media Library. Any Media Clips will be added to the Gift via a URL from the Media Database once the Gift(s) is(are) sent.

At a step M4, the Merchant sets the value of the Gift. The Merchant has the option to set a conditional amount to be spent before the Gift may be redeemed. For example, the Merchant can give a $20 Gift with no conditional value, or can give $20 if the Recipient spends $50.

At step M5, the Merchant is taken to a confirmation screen and has the option to edit any of the inputs. Once complete, the Merchant clicks send.

At step M6, unique Gift IDs are created for each of the Recipients in the Gift Database 42. These Gifts are typically marked with a “Non Exchangeable” flag, and the system 20 will not allow Merchants identified in such Merchant established Gifts to be exchanged for another Merchant.

At a step M7, the Media ID and/or URL from the selected Media Clip(s) is(are) added to the Gift Data.

At step M8, the transaction amount and any associated condition(s) is(are) saved in the Transaction Database 46. That information is then populated into the Gift Data associate with that Merchant Gift.

At step M9, the Recipient(s) is(are) saved into the User Database 40 and populate into the Gift(s).

At step M10, notifications are sent through an API defined by the notification system 36 to external notification systems (e.g., via SMS text and email (depending on what Recipient information was provided)).

The unregistered Recipient signs up as a Customer at step M11. When the Customer/Recipient signs up after receiving a Merchant Gift, a record of the Merchant being the referring party is made in the database, to later offer free or discounted transactions for the benefit of that Customer with the referring Merchant. When a Gift has been claimed, the status of the Gift changes to show that the Gift has been received.

The Merchant can view Gifts pending redemption in their Merchant Application 34 at step M12.

Step M13 confirms that Merchant Gifts are redeemed with the Merchant that established the Gift. Merchant Gifts thus may not be exchanged for another Merchant. The Gift Redemption Process discussion herein describes the process of redeeming gifts in detail.

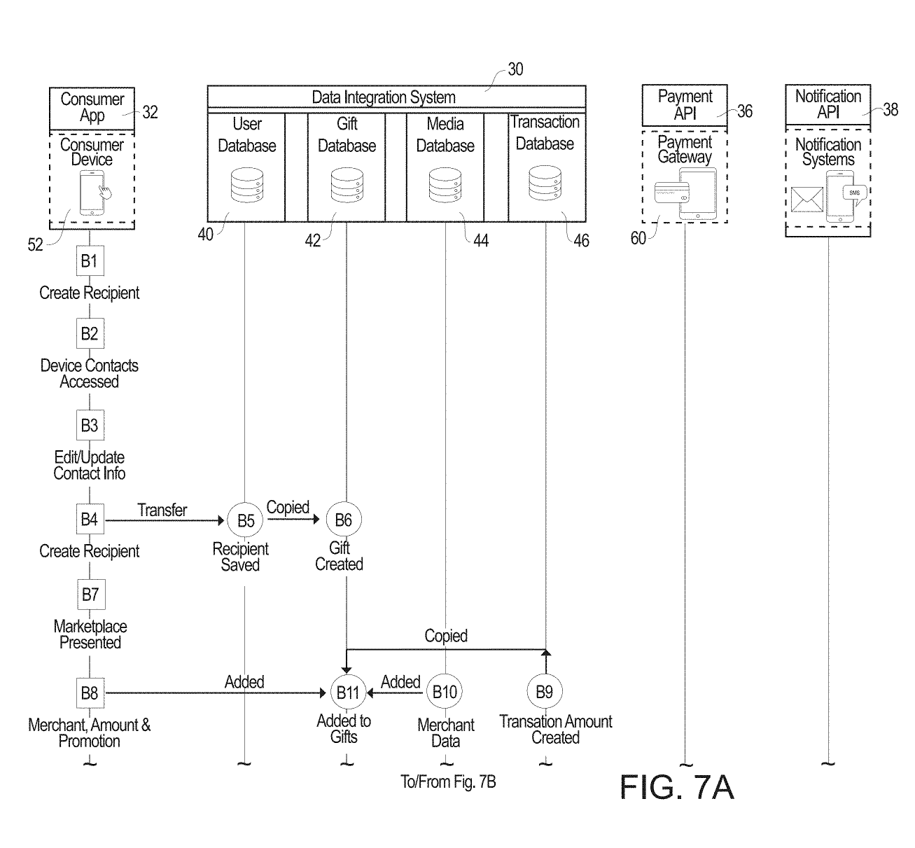

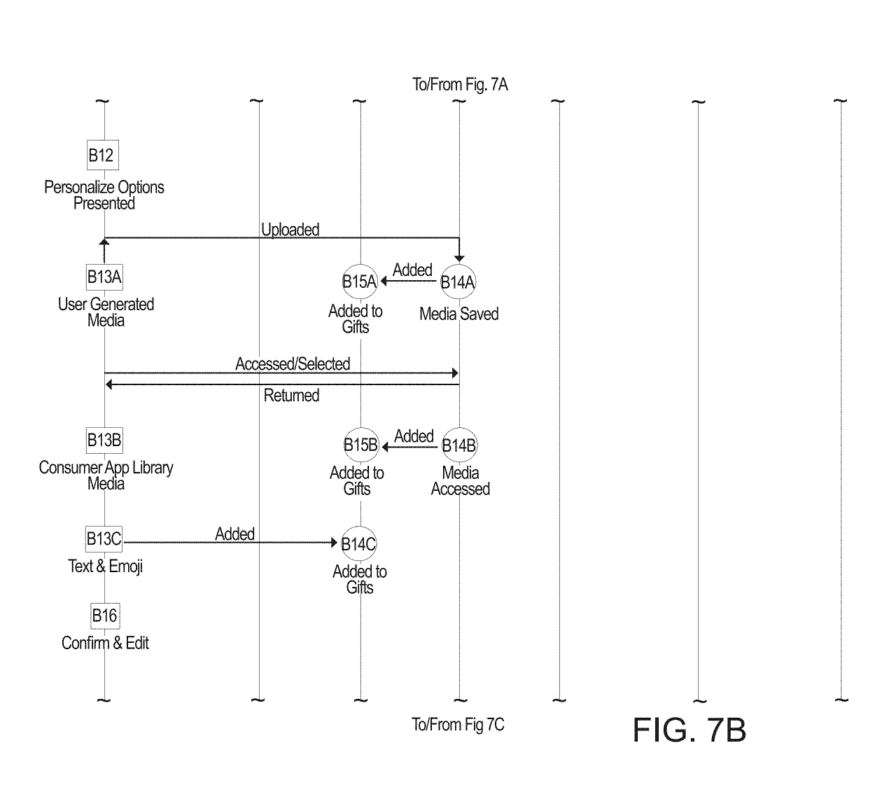

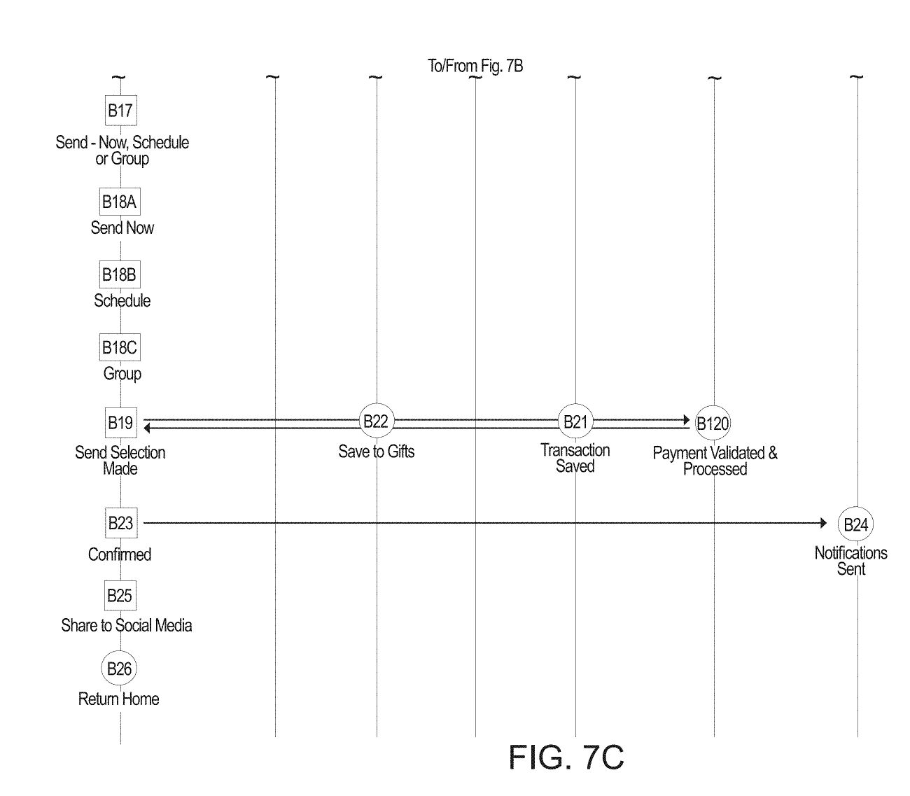

An example Consumer Build Process will now be described with reference to FIGS. 7A, 7B, and 7C. The example Consumer Gift Build Process begins at step B1. At step B1, the Create Recipient icon in the Customer Application 32 is selected by the Giver to create a new Gift Recipient. If the Recipient was previously added to Gift Recipients, that person can be chosen from a list.

At step B2, contacts are accessed from the contacts on the Giver's device if available, and presented in the Customer Application 32. Customers can select a contact, or search for a contact. If the contact is not in the Customer Device 52, the Giver can create a new contact in the Customer Application 32.

At step B3, the Recipient's contact information is imported into a Gift form, and the Giver can edit email address, mobile phone number and City and State to ensure delivery of the Gift. At step B4, the Recipient's information is saved in the Customer Application 32, including a photo of the Recipient if available.

The Recipient information is stored in the Customer Device 52 and is transferred to the User Database 40 at step B5 upon purchase of the Gift. The Recipient information is also copied to the Gift Database 42 at step B6 when the Gift is purchased. A new Gift ID is generated when the Gift Data is stored.

The Merchant Marketplace is presented to the Giver at step B7. The details of the creation of the Merchant Marketplace are described elsewhere.

The Giver selects the Merchant at Step B8 by selecting a Merchant from the Marketplace, choosing an amount (which is adjustable) for the Gift. If any promotions are available, the Giver could also choose a promotion. This information is held in the mobile device memory until the Gift is purchased. Once the Gift has been purchased, the Merchant Data and Promotion Data are stored. If the Gift is not purchased, or cancelled this information is deleted.

The transaction amount is created in the Transaction Database at step B9. The Transaction amount and is referred to by the Gift ID. Upon purchase that information is added to the Gift Database 42. At Step B10, the Identifier for the Merchant's Gift offer is attached to the Gift Data entered into the Gift Database 42 to allow for up-to-date store location and videos to be presented with the Gift. At step B11, Merchant components are added to the Gift upon purchase.

At step B12, Gift personalization options are presented to the Giver. The Giver has three options for personalizing the Gift, and, in addition, a “skip” option.

The first option is for the Giver to generate media B13a. Customer media can be generated in three ways. First, the Giver may take a video “selfie” through the camera interface defined by the Customer Application 32. Second, the Giver may take a still “selfie” through the camera interface defined by the Customer Application 32. Third, the Giver may select a still image or video from the camera library of the Customer Device 54. At step B14a, the Customer generated media is saved to the Media Database 44. In addition, a unique URL is created and is compiled with the Gift upon purchase as shown at B15a.

The second option is for the Giver to utilize System Media Clips as shown at step B13b. In particular, the Customer can access media (video, stills, music) in the System Media Library. The Customer can preview the media and select, or choose different media stored in the System Media Library by the operators of the Data Integration System 20. The media data associated with Media Clips stored in the System Media Library is stored in the Media Database 44. The media is selected at B14b. The unique URL for the selected media is added to the Gift upon purchase at step B15b.

The third option is for the Giver to type a text message, including text and/or emoji's at step B13c. This option can be used in combination with Giver or System generated Media Clips. The text and emoji's are added to the Gift Data at step B14c upon completion of the purchase of the Gift.

Once the personalization is complete, the Giver is taken, at B16, to a user interface screen that includes all of the elements of the Gift. The Giver can edit any of these elements, cancel the Gift, or save the Gift. If the Gift is cancelled, the information held in the Customer Application 32 on the Customer Device 52 will be deleted and will not be populated into any of the databases of the Data Integration System 20.

Upon Confirmation of the Gift at step B17, the Giver is taken to the screen to Send the Gift. The Giver can send the Gift immediately, schedule to send the Gift at another time, or choose Group Gift and add others to the Gift. The Customer can change payment information on this screen and is prompted to add payment if this information has not already been stored in the System 20.

A Send Now step may be selected at B18a, at which point Gift transaction is finalized and processed.

A Schedule step may be chosen at B18b. When the Schedule step is selected, the Giver is brought to a screen to pick the date and time at which the Gift is delivered. The Giver selects and confirms the delivery date and chooses send. The Gift transaction is finalized and processed.

Step B18c allows a Giver Group Gift to be purchased. A Giver Group Gift allows multiple people to contribute money and greetings to the Recipient. The Giver is brought to a screen to pick Recipients of the Recipient Group Gift invitation. The Giver chooses Recipients from contacts database on the Customer Device 52, or adds a new contact(s). The Giver creates a custom message in text or in a video to be sent in the invitation to the group. The Giver chooses a delivery time and date of the Gift. A notification is added to the invitation letting invitees know by when they need to add to the Gift. The Giver is brought to a screen to confirm the details and may edit any component. The Giver confirms, and the transaction is processed. Please see the Group Build schematic for details on how others add to the Gift.

Upon making a Send choice at step B19, a validation of the Credit Card occurs with the payment gateway. If the card is validated, the Gift notification is sent. The Gift notification may be scheduled or a group invitation sent depending on the choice. If not, the Giver is instructed to utilize another credit card. Once the credit card is validated, the Gift amount is posted to the Transaction Database with the unique Gift ID at step B20.

Once the credit card is validated, the amount is transmitted at step B21 from the Transaction Database 46 to the Gift Database 42 to populate the Recipient's Gift. All of the other components of the Gift that may be been stored in temporary memory are now added to the Gift Data that is stored in the Gift Database 42.

Once the credit card is validated, the Giver is presented with a “Sent” confirmation step B22 if sent immediately. If the Gift has been scheduled the Giver sees a “Scheduled” confirmation. The Giver sees a “Notifications Sent” confirmation. Once the Gift notification is sent (regardless of date) notifications via text and email (if both were entered) are sent to the Gift Recipient. Please see Gift Receive schematic for details about redeeming gifts.

The example Data Integration System 20 sends messages at step B23 using the notification system 38 (e.g., notification API) to external email and SMS notification systems to send a notification of the Gift to the Recipient. If the Recipient is already enrolled in the Data Integration System 32, a notification may also be sent by the Data Integration System 20.

If the Gift notification is sent immediately, upon the “Sent” confirmation at B24, and the Giver is directed to a screen providing the ability to post Gift details to their account in one of several Social Media outlets. If they choose to post certain details about the received Gift to a Social Media account, the Giver is instructed to login to the account, and the Gift Post is started for them. They can then edit the post and submit the post as normal through that account. Alternatively, the Giver can choose to make the Gift private. If the Gift is Scheduled or a Group Gift is given, the Giver is taken back to the home screen of the Customer Application 32.

Once the Gift Process is completed, the Giver chooses “Done” at step B25, and, at step B26, the Giver is returned to the home screen of the Customer Application 32.

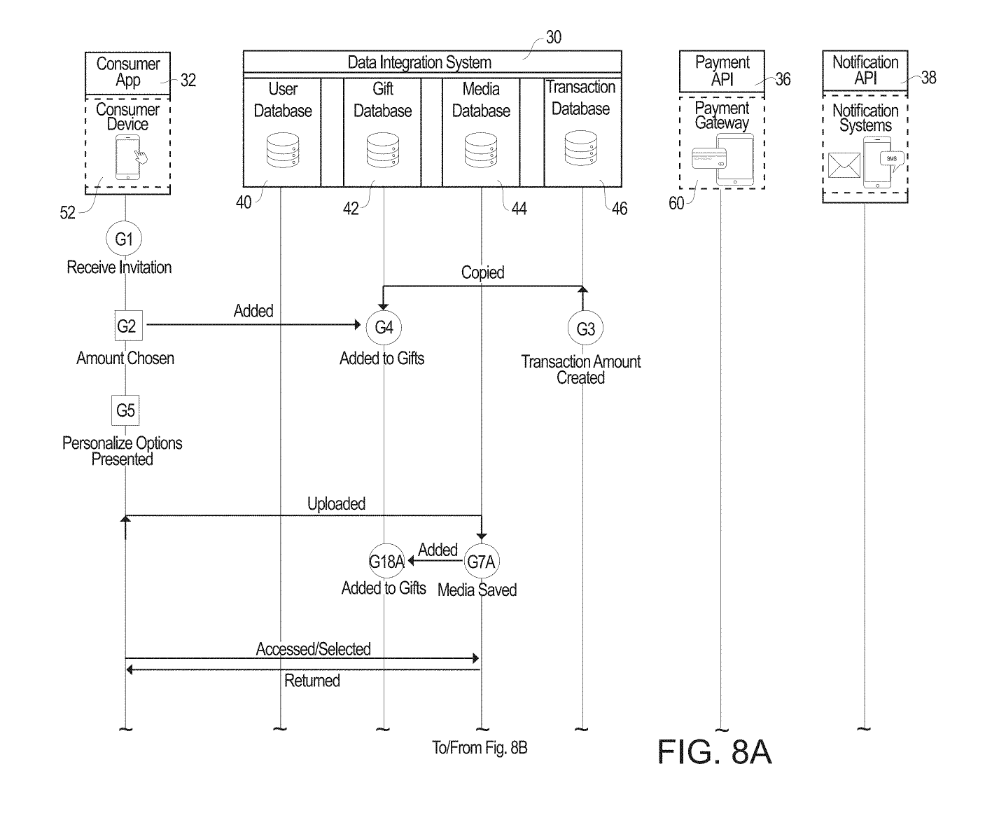

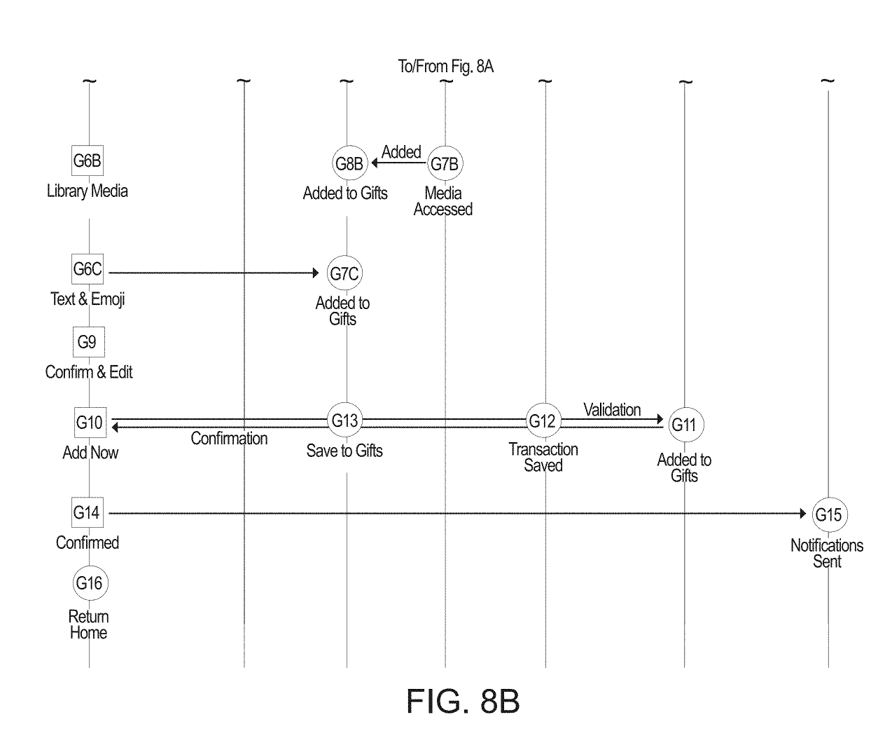

An example Group Build process will now be described with reference to FIGS. 8A and 8B. The process starts with an initiating Giver establishing a Giver Group Gift as described herein. At that time, the initiating Giver identifies additional Givers who may want to participate in the Giver Group Gift. When the initiating Giver identifies the gift as a Giver Group Gift, an invitation is presented at step G1 to the additional Givers identified by the original Giver to add both money and greetings to the Giver Group Gift. The additional Givers will be prompted to download the Giver Group Gift and/or login if they already are enrolled.

At step G2, the Merchant selected by the original Giver will be presented. The additional Giver(s) will select the amount of an Additional Gift Value to be added to the Giver Group Gift. The Additional Gift Value is held in the Customer Application 32 storage, and upon purchase the amount of the Additional Gift Value will be added to the Transaction Database at step G3. The Additional Gift Value amount will be added to the previous value of the Giver Group Gift upon purchase at step G4.

The Giver Group Gift personalization options are presented to the additional Giver at step G5, where the additional Giver has three personalization options and a “skip” option. The first option, presented at step G6a, is for the additional Giver to generate Media Clips. Customer media can be generated in three ways. First, the additional Giver may take a video “selfie” through the camera interface defined by the Customer Application 32. The additional Giver may take a still “selfie” through the camera interface defined by the Customer Application 32. Third, the additional Giver selects a still or video from the camera library on the Customer Device 52. At step G7a, the Customer generated media is saved to the Media Database 44. At step G8a, a unique URL is created and is compiled with the Gift Data upon completion of the purchase of the Giver Group Gift.

The second option is for the additional Giver to utilize System Media Clips. At step G6b, the additional Giver can access Media Clips (e.g., video, stills, music) in the System Media Library. The Customer can preview System Media Clips and choose a desired System Media Clip. The desired System Media Clip is selected at step G7b. At step G8b, the unique URL for the selected media System Media Clip is added to the Gift data upon completion of the purchase of the Giver Group Gift.

The third option is for the additional Giver to type a message including text and/or emoji's at step G6c. This option can be used in combination with Giver or System generated Media Clips. At step G7c the text and emoji's are added to the Giver Group Gift upon completion of the purchase of the Giver Group Gift.

Once the personalization is complete, the additional Giver is taken to a screen at step G9 where the elements of the Giver Group Gift are displayed. The additional Giver can edit the amount and the personalization, can cancel their contribution to the Giver Group Gift, or finalize and save the Giver Group Gift. If the Giver Group Gift is cancelled, all of the information held in the Customer Application 32 on the Customer Device 52 will be deleted and will not populate in the Data Integration System 20. If the additional Giver chooses to finalize and save the Giver Group Gift, the additional Giver will then choose to Add their amount and personalized message at step G10. Upon completion, a validation of the Credit Card using the payment system 36 is performed at step G11. If the card is validated, the amount of the Additional Gift Value is added to the Giver Group Gift. If not, the additional Giver is instructed to utilize another credit card. Once the credit card is validated, the Additional Gift Value is posted to the Transaction Database 46 with the unique Gift ID at step G12.

When the Additional Gift Value has been posted to the Transaction Database 46, the Additional Gift Value is retrieved from the Transaction Database and stored in the Gift Database 42 and will be reflected in the Customer Application 32 of the additional Giver. All of the other components held in temporary memory, are now added to the Gift. At this point, the Giver sees an “Added” confirmation on the user interface of the Customer Application at step G14.

On the date and time selected by the original Giver, at step G15 the example Data Integration System 20 sends messages via the Notification System (e.g., Notification API) to external email and SMS notification systems to cause a notification of the given Giver Group Gift to be sent to the Recipient(s) of the Giver Group Gift. If the Recipient is already enrolled in the example Data Integration System 20, a system notification will also be sent.

Once confirmed, the additional Giver is taken back to the home screen of the Customer Application 32 at step G16.

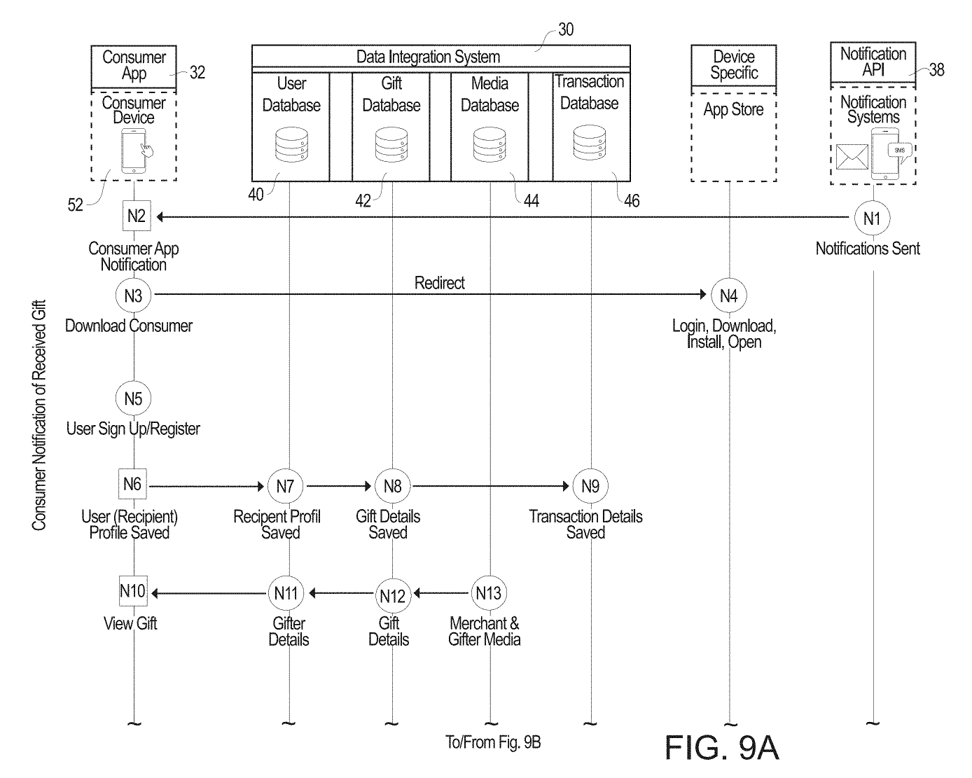

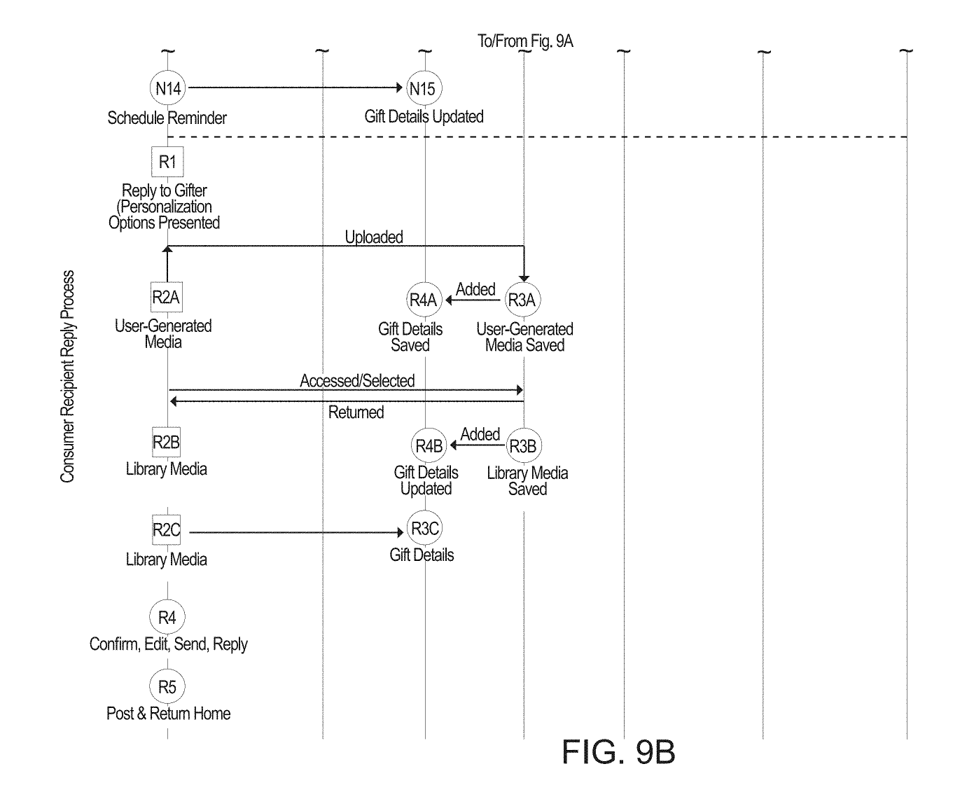

Referring now to FIGS. 9A and 9B of the drawing, an example Recipient Notification Process will now be described in further detail.

At step N1, the example Data Integration System 20 sends messages via an API to external email and SMS notification systems to send a notification of the Gift to the Gift Recipient at the date and time selected by the Giver (or original Giver for Giver Group Gifts). If the Recipient is already enrolled in the example Data Integration System 20, a system notification will also be sent.

At a Receive Notification step N2, the Recipient receives text, email and/or in-app notification that a Gift has been established in the mane of the Recipient. At a Download Customer App step N3, the unregistered Recipient can download from device-specific App Store if Customer does not yet have the Customer Application 32 or a Customer Account. At a Login, Download, Install, Open step N4, the Customer will be guided through the installation and registration process. In particular, at step Customer Sign Up/Registration step N5, the unregistered Recipient enters personal details, payment method, and preferences. At step N6, the Recipient Profile is Saved in the app, including photo if available. At step N7, the Recipient Profile is Transferred, Updated and Saved to the User Database 40.

When the Recipient is registered, at step N8 Gift details are Transferred, Updated, and Saved to the Gift Database 42 in the name of the Recipient. At step N9, transactions Details including date/timestamp and Status are Updated and Saved to the Transaction Database 46. At that point, Gift Data is transferred to the Recipient's Customers Device 52 and viewed using the Recipient's Customer Application at a View Received Gift step N10.

In particular, at a Giver Details step N11, the details of the Giver are transferred to the Recipient's Customer Device 52 and presented to the Recipient using the Recipient's Customer Application 32. The Gift details, including identity of the Merchant, are similarly transferred to the Recipient's Customer Device 52 and presented to the Recipient using the Recipient's Customer Application 32 at a Gift Details step N12. Finally, the Merchant and/or Giver Media Clips associated with the Gift by Media IDs are transferred to the Recipient's Customer Device 52 and presented to the Recipient using the Recipient's Customer Application 32 at a Merchant/Giver Media step N13.

At a Schedule Reminder step N14, the Recipient can schedule a reminder and/or set notification preferences through the user interface of the Recipient's Customer Application 32. At a Save Gift Details step N15, the settings and/or preferences of the Recipient/Customer may be updated, and the updated settings and/or preferences are stored in the Gift Database 42.

After the Recipient Notification Process is complete, an optional Recipient Reply Process may be presented to the Recipient. An example of an optional Recipient Reply Process will now be described. At a Reply to Giver step R1, one or more reply personalization options are presented to the Recipient. In the example shown in FIGS. 9B, the Recipient is presented with three personalization options and a “skip” option at step R1.

The first option is a Customer-generated Media step R2a that allows the Recipient to generate Media Clips. Customer Media Clips can be generated in three ways. First, the Recipient takes a video “selfie” through the camera interface defined by the Customer Application 32. Second, the Recipient takes a still “selfie” through the camera interface defined by the Customer Application 32. Third, the Recipient selects a still or video from the camera library stored on the Customer Device 52. At a Save Customer-generated Media step R3a, the Recipient-generated Media Clip is saved to the Media Database 44. At step R4a, a URL unique to the Media Clip is created, transferred, and saved in the Gift Database 42.

The second option is for the Recipient to utilize System Media Clips. At a System Media Library Access step R2b, the Recipient can access video clips stored in the System Media Library. The Recipient can preview different media clips by category or the like and select a desired System Media Clip. At a Save System Media Clips step R3b, the System Media is selected from the System Media Library and Saved to the Media Database 44. At Gift details Updated step R4b, a unique URL to the selected System Media Clip is Created and Transferred to and Saved in the Gift Database 42.

The third option is for the Recipient to type a text message. At Media Clip option step R2c, the Recipient enters text, emoji, and the like. At an Update Gift Details step R3c, the Recipient's text message is added to the Gift Database 42.

To complete the Recipient Reply Process, the Recipient will send a reply to be delivered immediately to the Giver through the Customer Application 32 at a Confirm, Edit & Send Reply step R4.

At a Post & Return Home step R5, the Recipient is prompted to post the Reply to available Social Media channels (e.g. Facebook & Twitter). The Recipient may optionally make the Reply private. At this point, the Recipient Reply Process is complete, and the Gift is closed, and the Recipient is returned to the Home Page of the Customer Application 32.

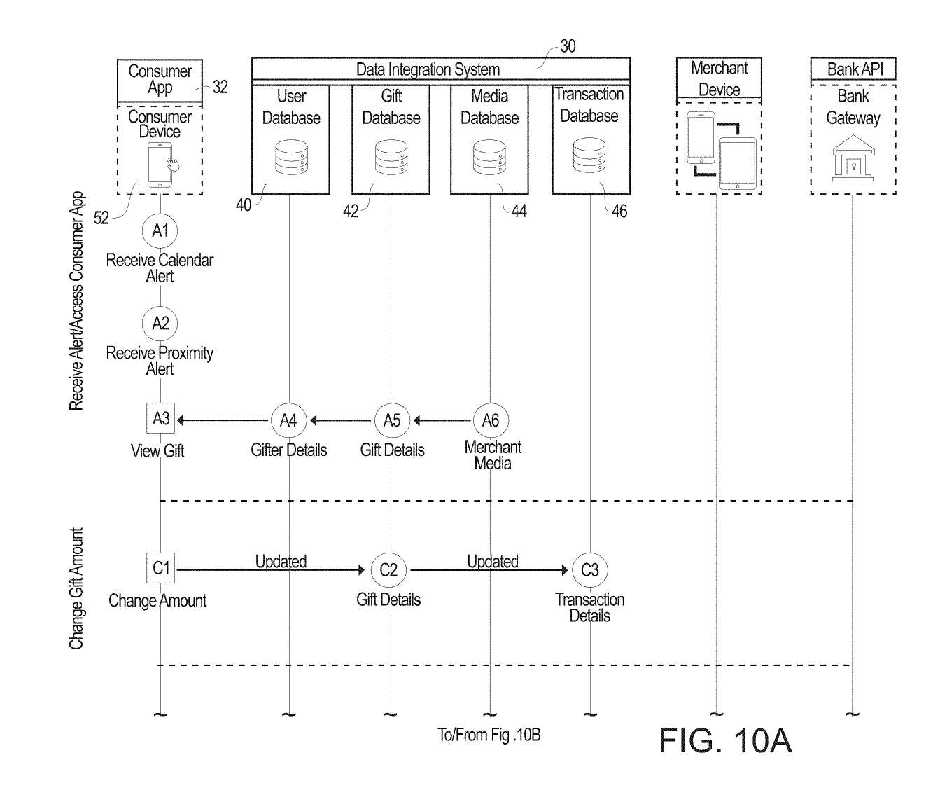

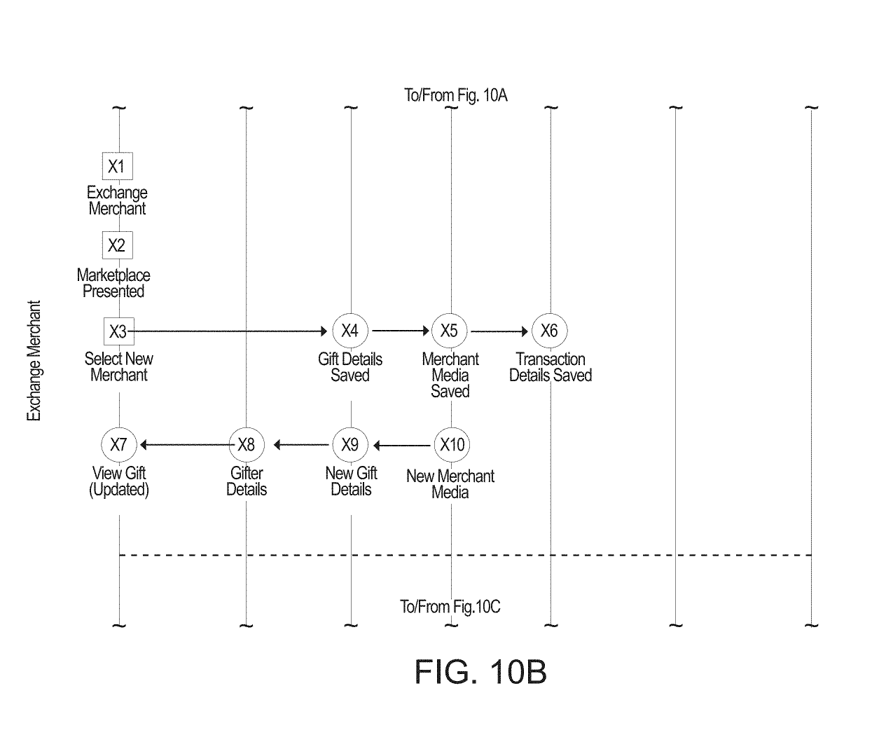

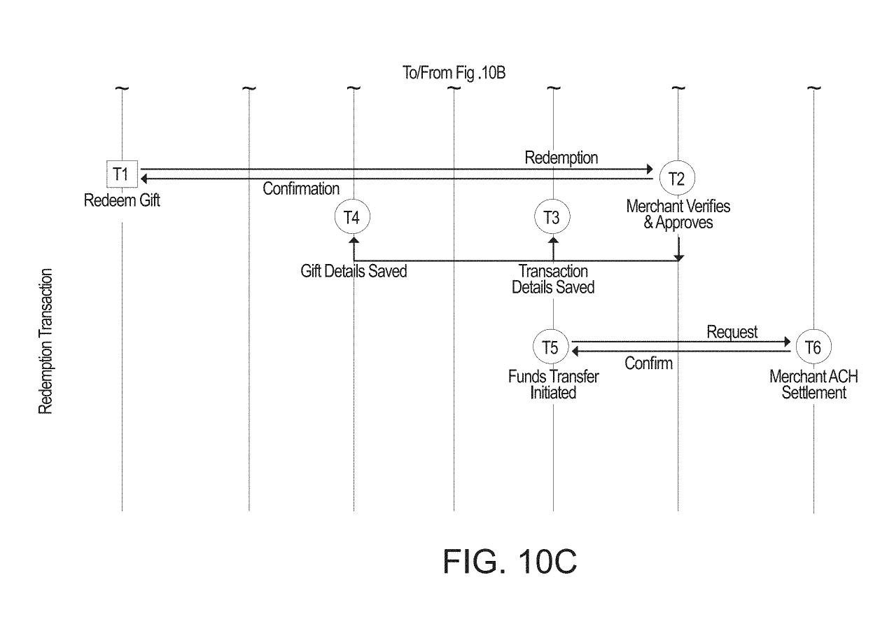

An example Redeem Gift Process will now be described with reference to FIGS. 10A, 10B, and 10C. The example Redeem Gift Process comprises a Receive Alert/Access Customer Application Process and an optional Change Gift Amount Process as shown in FIG. 10A, an optional Exchange Merchant Process as shown in FIG. 10B, and a Redemption Transaction Process as shown in FIG. 10C. Examples of the Receive Alert/Access Customer Application Process, the optional Change Gift Amount Process, the optional Exchange Merchant Process, and the Redemption Transaction Process will now be described.

FIG. 10A illustrates that the Recipient receives notification or alert reminding the Recipient of the existence of the Gift at a Receive Calendar Alert step A1. In addition or instead, the Recipient may receive notification or alert notifying the Recipient that the Recipient's physical location is proximate to the Merchant associated with the Gift at a Receive Proximity Alert step A2. The Recipient is prompted to view the Gift at step A3. If the Recipient elects to view the Gift, the Gifter details are retrieved at step A4, the Gift details are retrieved at step A5, and the Merchant and/or Giver Media is retrieved at step A6. The Giver details, Gift details, and any media clips associated with the Gift may be viewed by the Recipient using the Customer Application 32 on the Recipient's Customer Device 52. The Recipient may elect to redeem the Gift at this point.

Optionally, the Recipient has the opportunity to change the Gift Value before the Gift is redeemed as shown at step C1 in FIG. 10A. In particular, at a Change Amount Step C1, the Recipient is presented with the option to change the Gift Value (e.g., the amount to be redeemed). If the Recipient enters a new Gift Value, the Gift Data reflecting the change to the Gift Value are transferred to and save to the Gift Database 42 at a Gift Details Saved step C2. At a Save Transaction Details step C3, the increase to the Gift Value and new balance of the Gift Value are saved to the Transaction Database 46.

The Recipient additionally has the opportunity to change the Merchant associated with the Gift using an optional Exchange Gift Merchant Process before the Gift is redeemed as shown in FIG. 10B. In particular, at an Exchange Gift Merchant step X1, the Recipient is presented with the option to Change the Merchant associated with the Gift. At a step X2, the Merchant Marketplace appropriate for the Recipient is presented based on the Recipient's physical location or other parameters. Please see the discussion of the Creation of the Merchant Marketplace schematic for details about the Merchant Marketplace.

At a Select New Merchant step X3, the Recipient is allowed to exchange the original Merchant for a new Merchant selected from the Merchant Marketplace. At a Save Gift Details step X3, the Gift data reflecting the new Gift details is transferred and saved to the Gift Database 42. At a Save Merchant Media step X5, the Media ID(s) of the Merchant Media Clips associated with the newly selected Merchant is(are) saved to the Gift Database 42. At a Save Transaction Details step X6, new Transaction Data reflecting the change in the Merchant are saved in the Transaction Database 46. At a View Gift step X7, the updated Gift Data is transferred to the Customer Device 52. At a Giver Details step X8, the Giver Data associated with the updated Gift is transferred to the Customer Device 52. At a View Gift Details step X9, the Gift Data reflecting the new Merchant may be viewed using the Customer Application 32 on the Customer Device 52.

Additionally, at a Merchant Media Step X10, the Merchant Media Clips associated with the new Merchant are transferred to the Customer Device 52 and may be viewed using the Customer Application 32 on the Customer Device 52.

Referring now to FIG. 10C of the drawing, depicted therein is an example Gift Redemption Transaction process. At a Redeem Gift step T1, the Recipient initiates a Redeem Process. At a Merchant Verification and Approval step T2, the Merchant verifies and approves the Transaction using the Merchant Device 54 and the Merchant Application 34 to approve Redemption Request. At a Save Transaction Details step T3, Transaction Data associated with Transaction Details is saved in the Transaction Database 46 to reflect Redemption Status and new Gift Value balance, if the Gift Value balance is greater than zero. At a Save Gift Details step T4, the Gift Data reflecting the Gift Details is saved in the Gift Database 42 such that the Gift Data accurately reflects the status and balance of the Gift after the Redemption Transaction.

At an Initiate Funds Transfer step T5, the Data Integration System 20 aggregates a single day's transactions stored in the Transaction Database 46 and initiates a batch ACH transfer of funds from the Escrow account to the Merchant Payment Accounts associated with each Merchant for which transactions have been processed the using the Payment System 36 and Payment Services System 60. At a Merchant ACH Settlement step T6, Merchant Transactions are Reconciled, and confirmation that the accounts have reconciled is transferred to the Merchant and to the example Data Integration System 20.

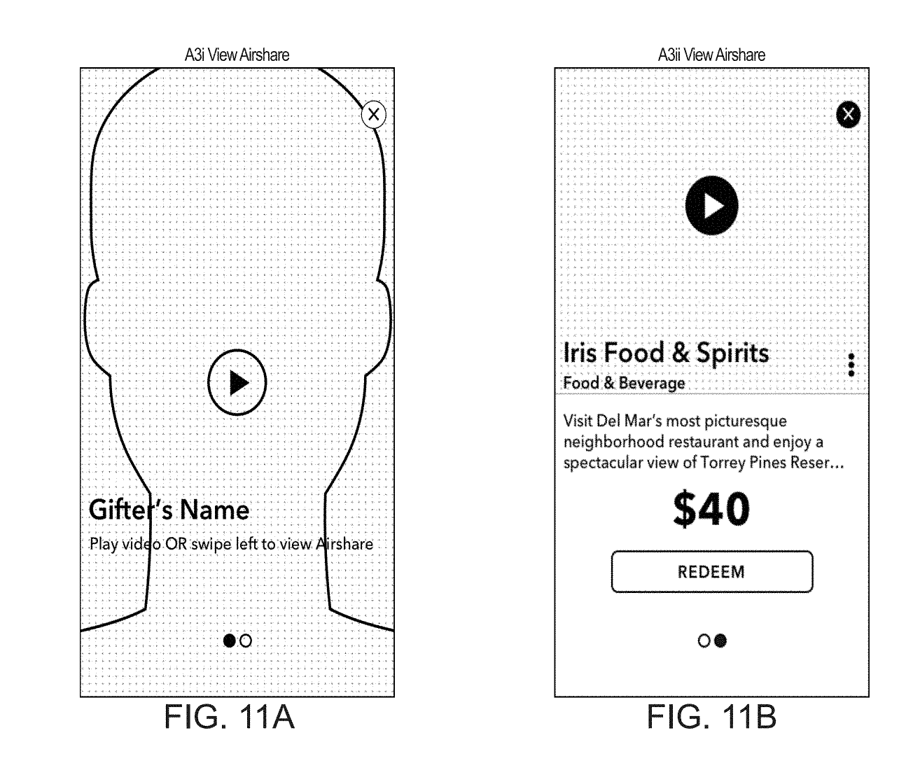

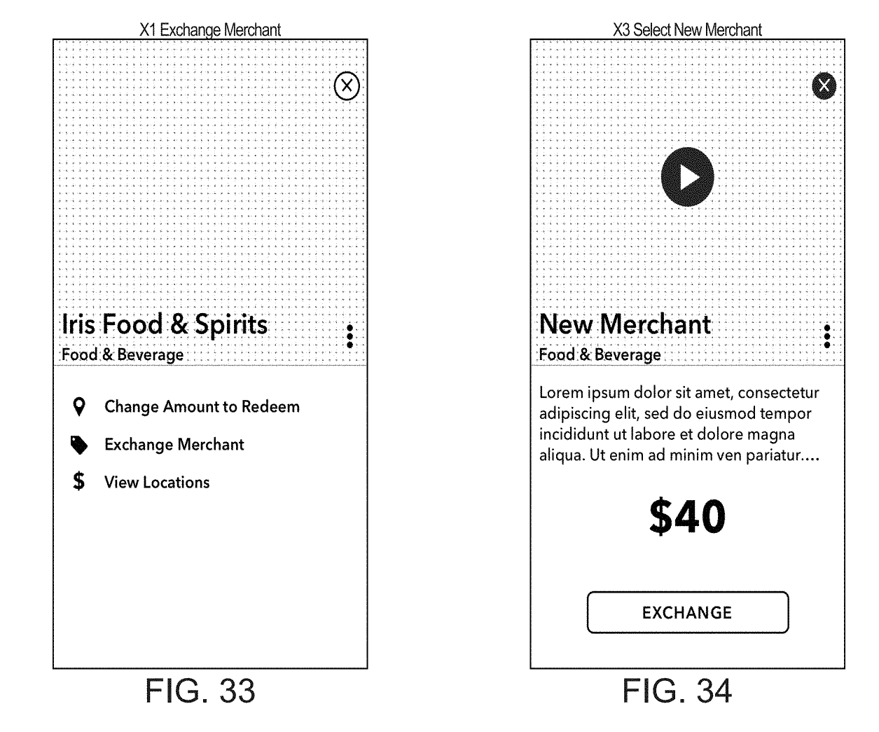

FIGS. 11-37 illustrate screen shots of example user interface elements that may be presented to the Customers by the Customer Application 32 when using an example of the Data Integration System 20. In the example screen shots depicted in FIGS. 11-37, the Customer Device is an iPhone, and the Customer Application that generates these user-interface screens is an iOS app that is downloaded from the Apple App Store. The screen shots depicted in FIGS. 11-37 thus assume user input is through direct manipulation using multi-touch gestures. Other makes of Customer Devices, associated operating systems, and user interface elements may be used in addition or instead.

FIG. 11A illustrates an example of a display of a Gift to a Recipient. The example display comprises a still image (shown in solid outline) and a Play button that allows a Gift Video Clip selected by the Giver to be played. Swiping the screen displays the details of the Gift as shown in FIG. 11B. The details of the Gift include the name of the Merchant and the Gift Value. A Play button allows a Gift Video Clip associated with the Merchant to be played. A Redemption Transaction for the Gift may initiated touching a Redeem button.

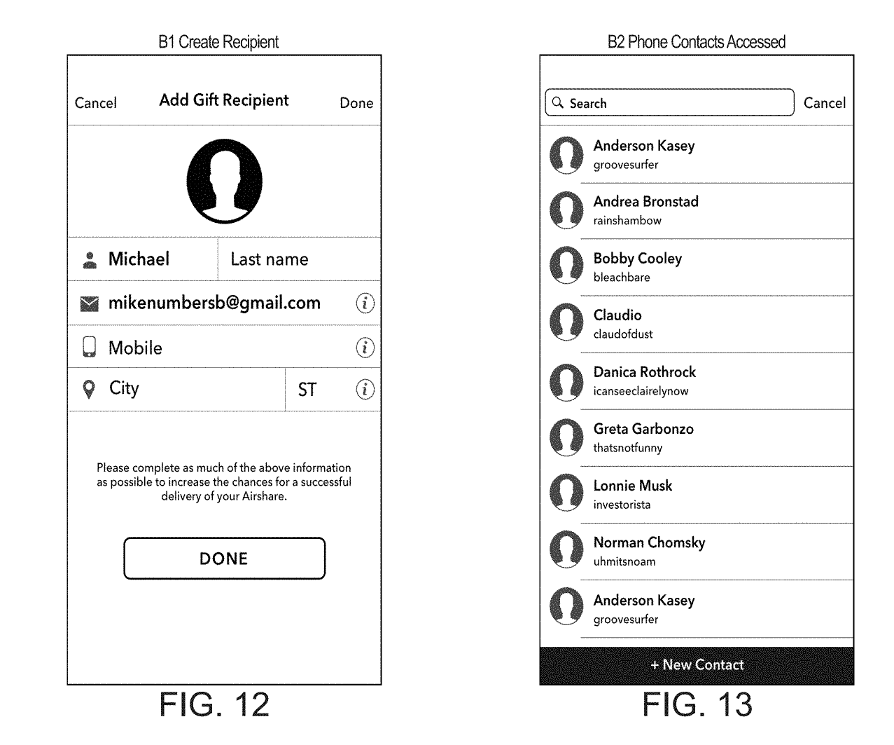

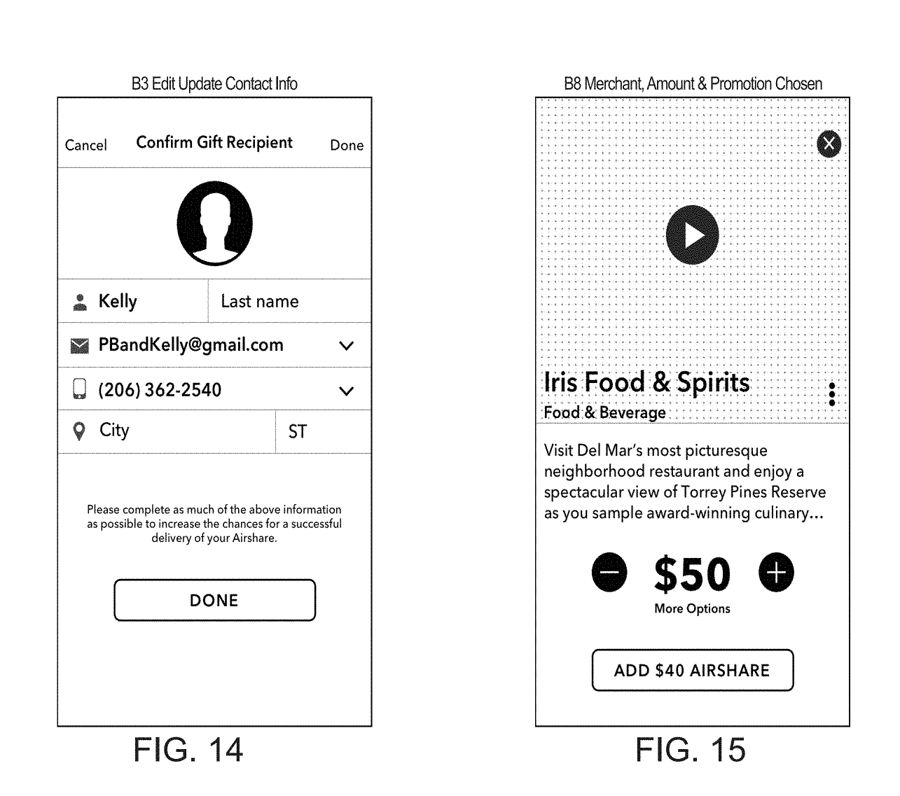

FIG. 12 illustrates an example of a screen for allowing the Giver to select or add a Recipient to a Gift. FIG. 13 illustrates a list of contacts displayed as potential Recipients for a Gift. The details of the particular Recipient may be confirmed as shown in FIG. 14. In FIG. 15, the Gift Value is selected by touching the increase (+) and decrease (−) buttons. The Gift Video Clip associated with the selected Merchant is also playable by pressing the Play button in FIG. 15.

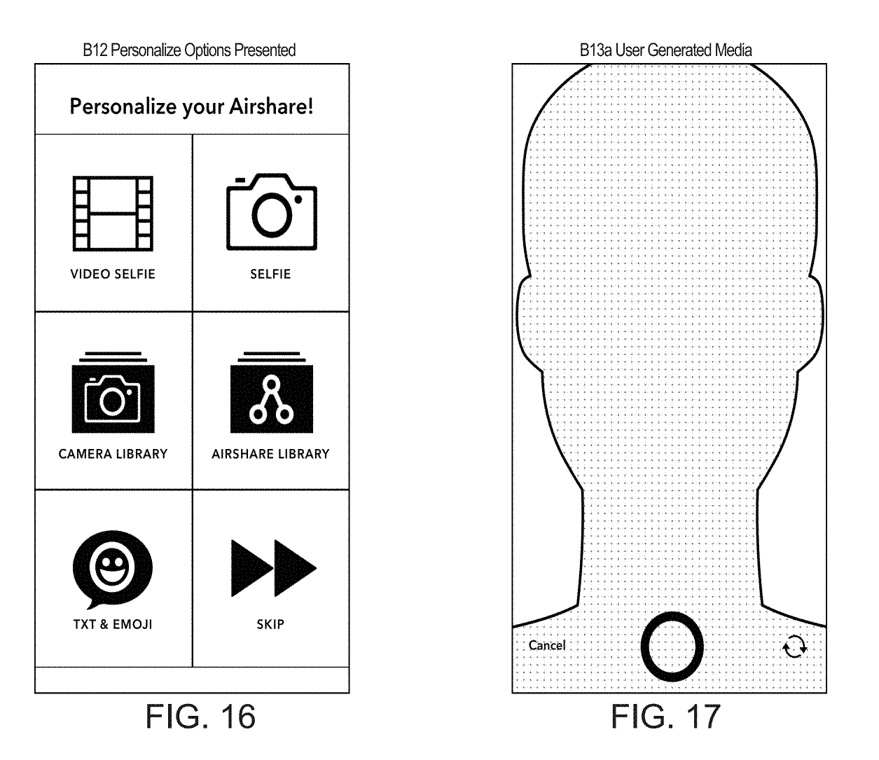

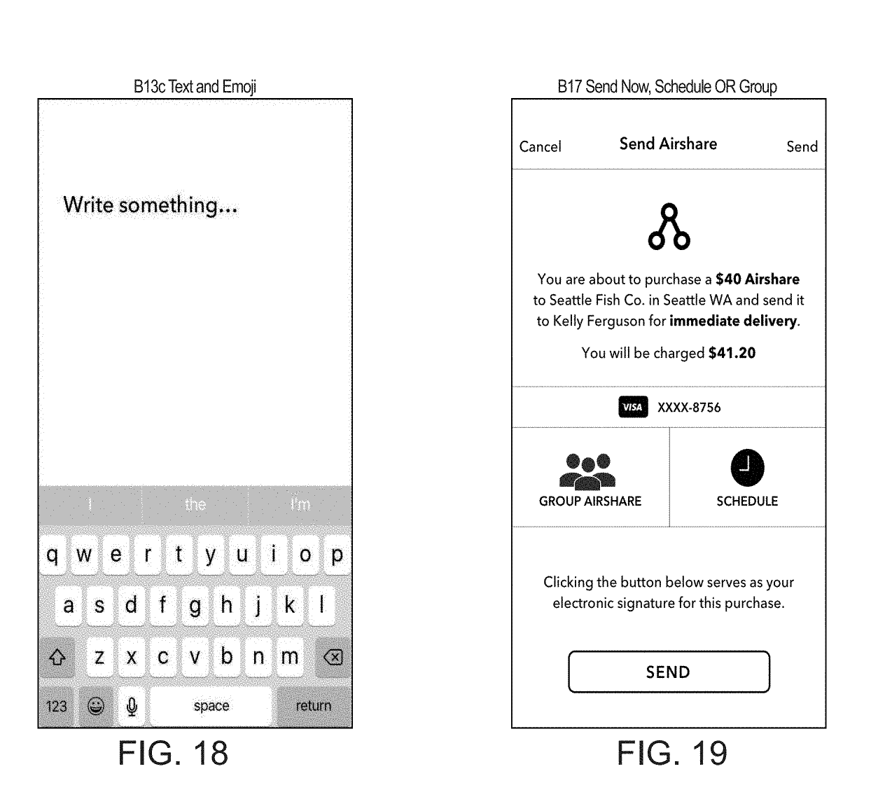

The Giver may generate or select a Gift Video Clip as shown in FIG. 16. If the Giver selects the Video Selfie button in FIG. 16, the user interface presents a video camera screen as shown in FIG. 17. Touching the Circle element in FIG. 17 starts and stops video recording. If the Giver selects the TXT & EMOJI button in FIG. 16, the user interface presents a data entry screen as shown in FIG. 18. Text and emoji may be entered by interacting with the Keyboard element shown in FIG. 18. If the Giver selects the AIRSHARE LIBRARY button in FIG. 16, the user interface presents a categorized list of System Video Clips as shown in FIG. 38. System video clips may be previewed and selected by interfacing with the individual entries in the displayed lists.

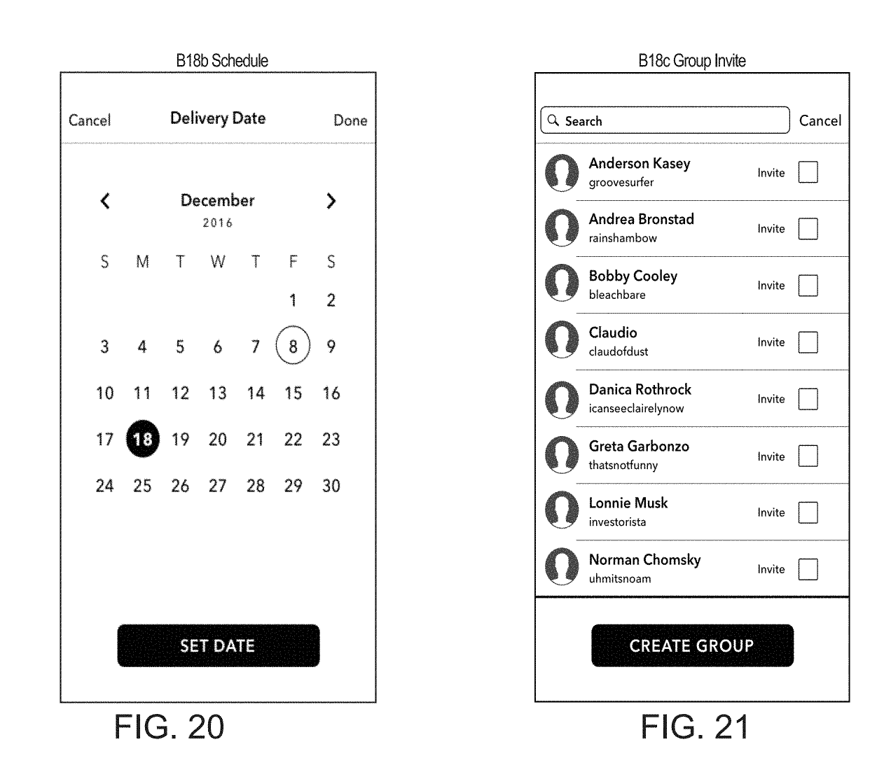

FIG. 19 illustrates an example of a user interface screen that allows the Giver to send the completed Gift to the Recipient. This screen summarizes current status of the Gift, allows the Giver to identify the Gift as a Group Gift, and allows the Giver to schedule the day on which the Gift is sent to the Recipient. If the Giver elects to schedule the day and time for sending the Gift, the Giver is presented with a Calendar screen as depicted in FIG. 20 to pick the day on which the Gift will be sent. If the Giver elects to make the Gift a Group Gift, the Giver is presented with a list of other possible Givers/Recipients as depicted in FIG. 21 to include in the Gift.

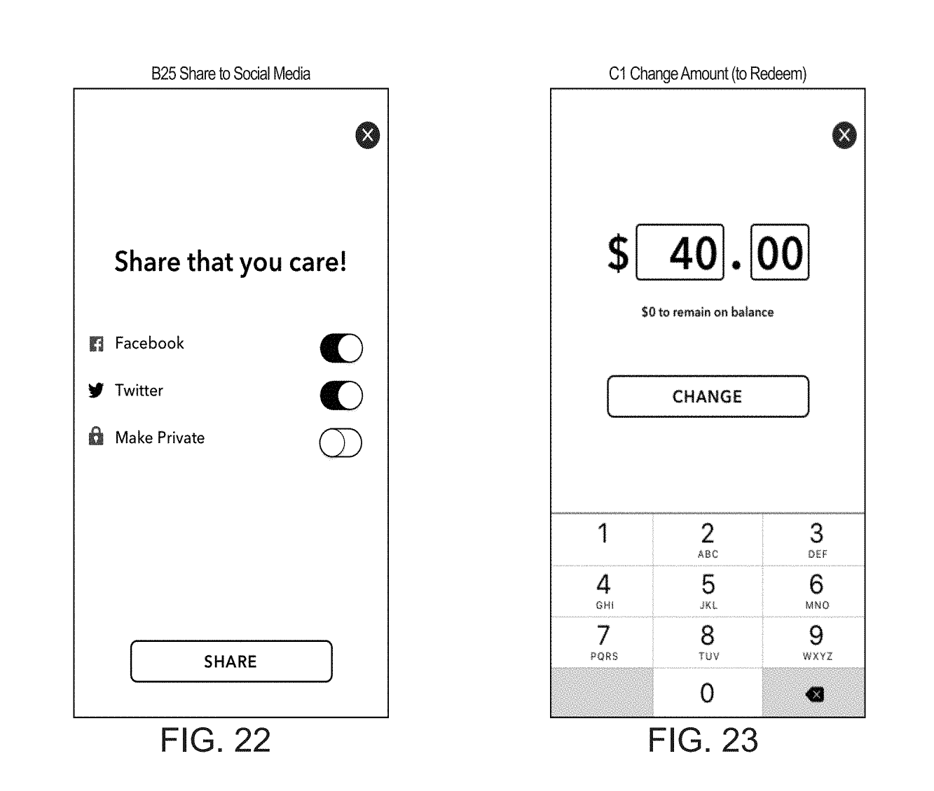

FIG. 22 illustrates an example interface screen that may be presented to allow Givers to notify others of the existence of the Gift by posting certain details of the Gift to social media accounts, in this case Facebook and Twitter. The Giver also has the option to make the Gift private.

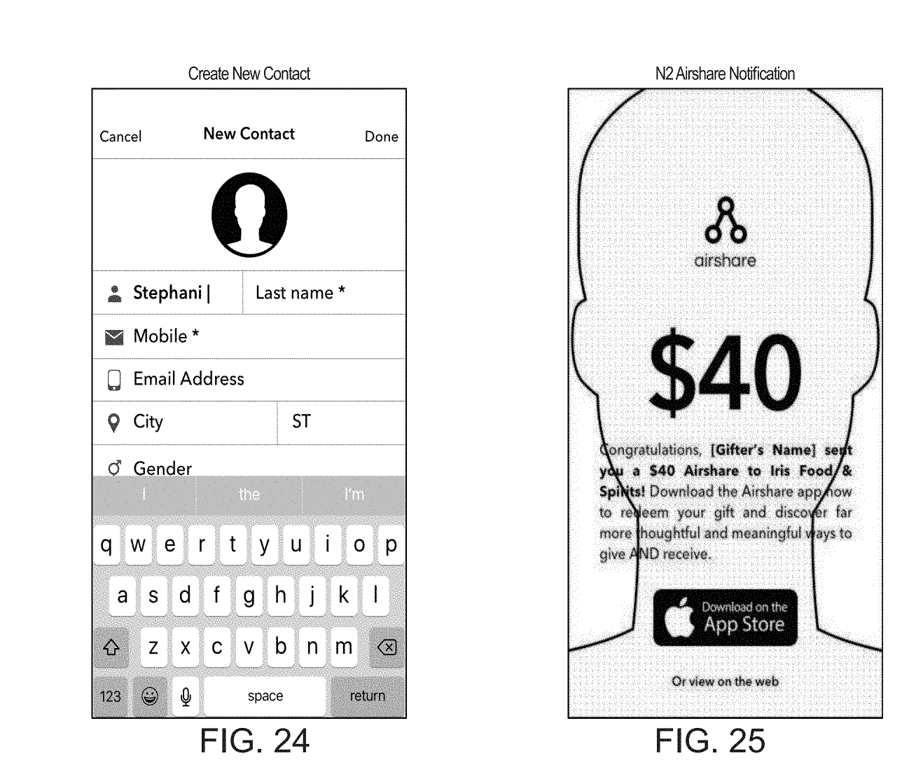

FIG. 24 illustrates a user interface screen depicting a new contact form that may be filled out when creating a new contact that may function as a Recipient.

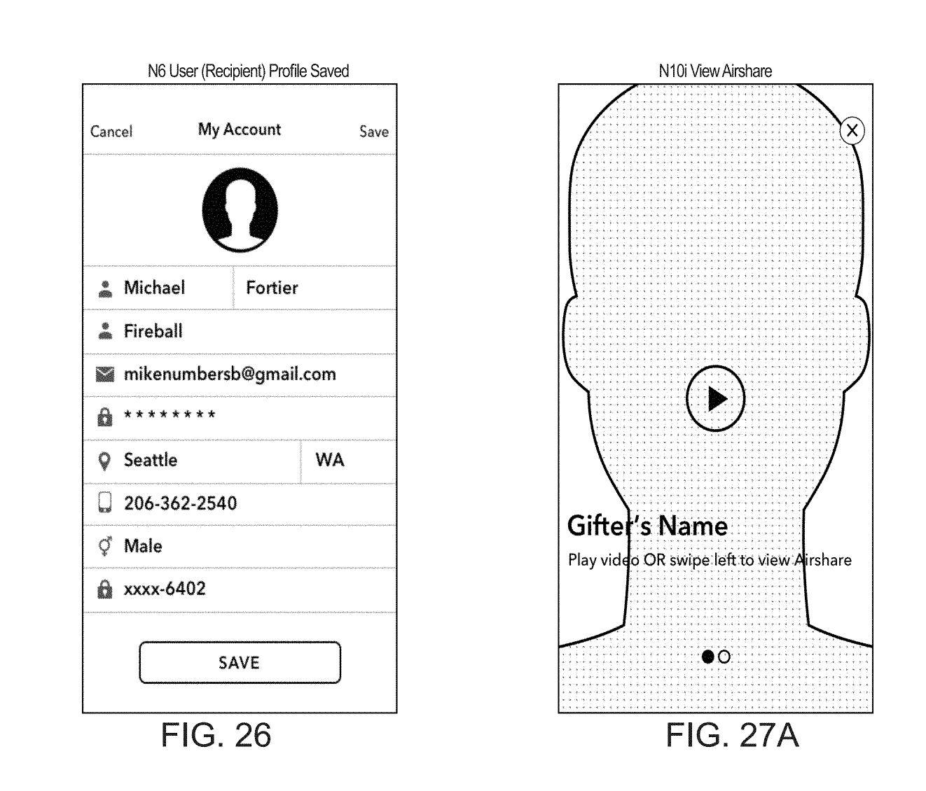

FIG. 25 illustrates a user interface screen depicting a Gift Notification screen that is displayed, after the Gift has been sent, to an unregistered Recipient. The unregistered Recipient may set up a Customer Account by downloading a copy of the Customer Application as shown in FIG. 25 and then entering in Customer Data into New Customer Form as shown in FIG. 26.

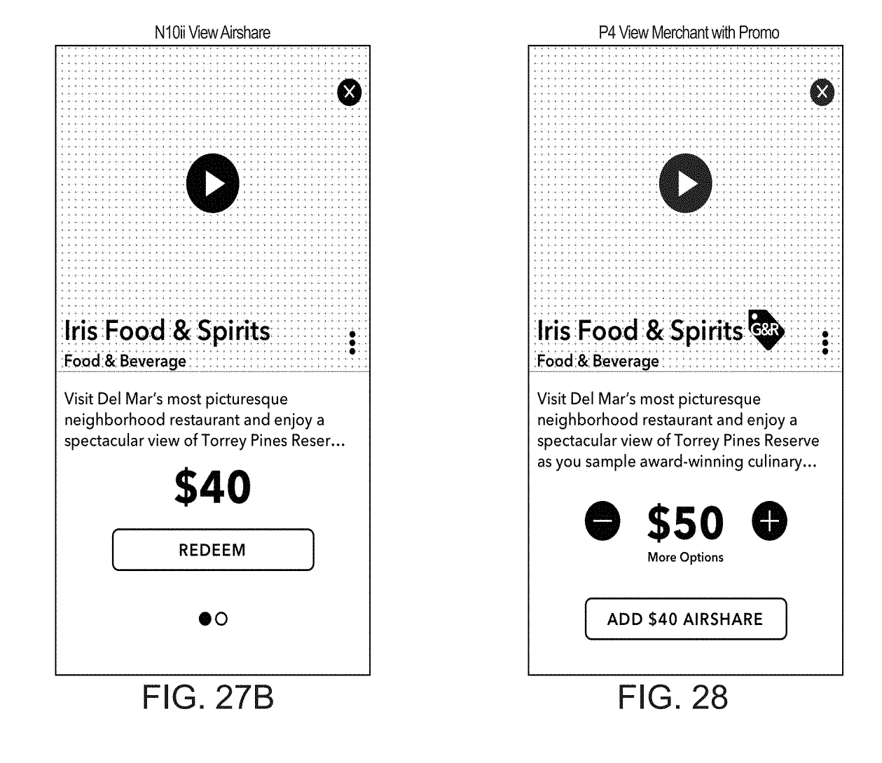

A Gift Media Clip is displayed to a previously registered or newly registered Recipient as shown in FIG. 27A. Pressing the Play button in FIG. 27A plays the Giver Media Clip associated with that Gift. Swiping the screen in FIG. 27A brings up a Gift Details screen that displays the details of the Gift and allows a Merchant Video Clip to be played by pressing a Play button as shown in FIG. 27B. The Recipient is given the option of adding value to the Gift Value as shown in FIG. 28.

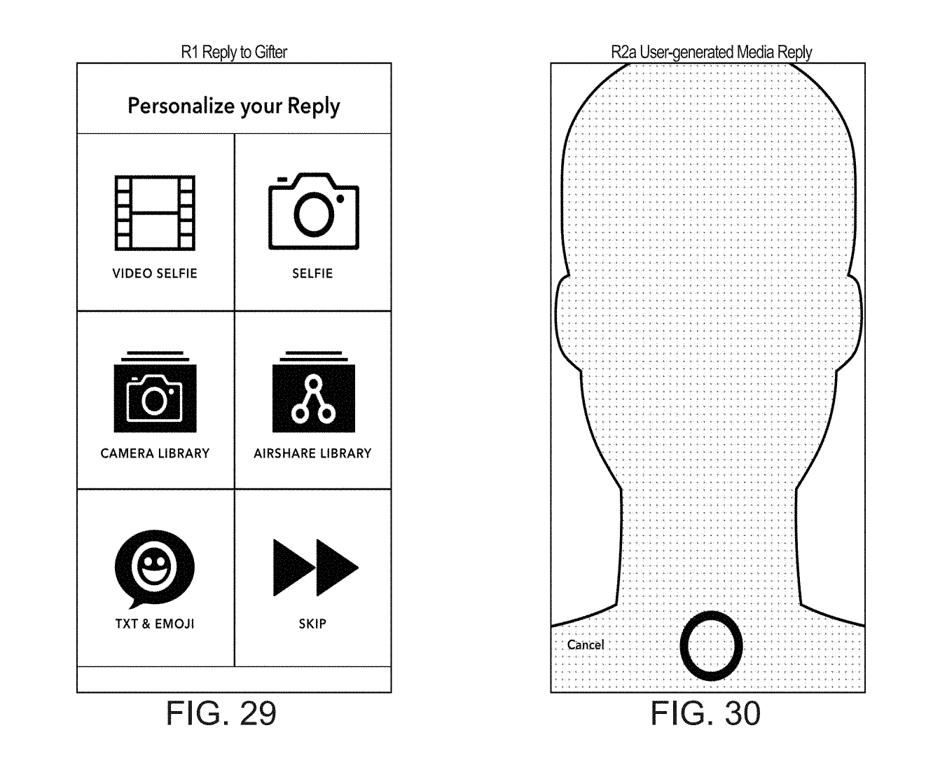

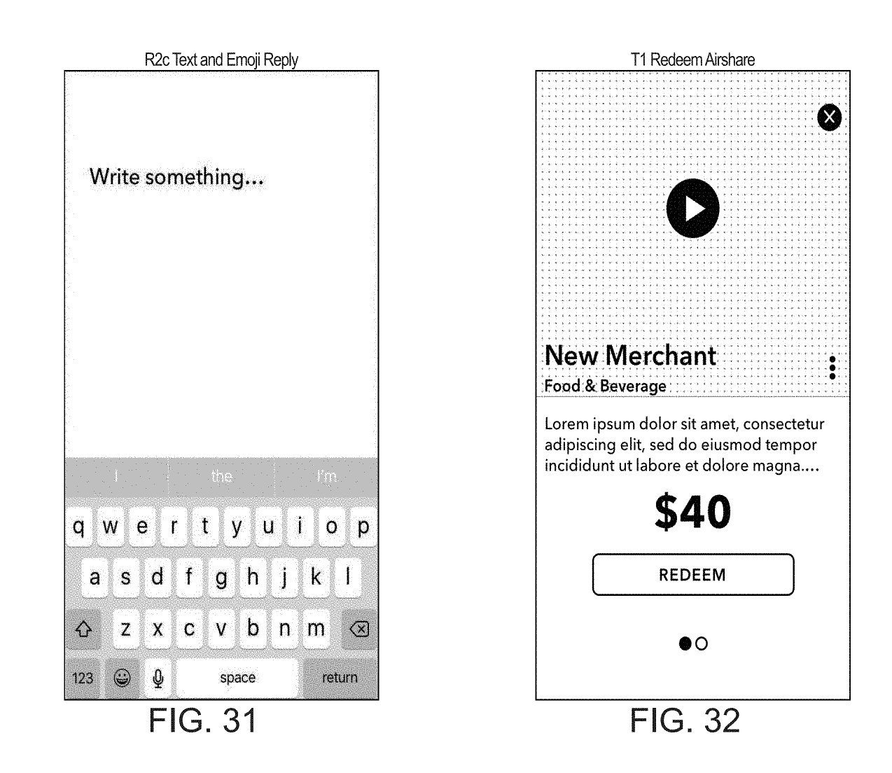

When the Gift has been received and/or redeemed, the Recipient may Reply to the Gift by choosing an appropriate option in FIG. 29. The Recipient may record a Recipient-created Reply Media Clip by pressing the VIDEO SELFIE button in FIG. 29 to bring up a video camera screen as shown in FIG. 30. Pressing the Circle button depicted in FIG. 30 starts and stops video recording. Other Reply Media Clip options may also be selected using the screen depicted in FIG. 29 such as by pressing a TXT & EMOJI button to go to a text and emoji entry screen as depicted in FIG. 31.

The Recipient may initiate a Redeem Gift process as shown in FIG. 32. To redeem, the Merchant name and Merchant Video Clip are presented along with the Gift Value and a Redeem button. Pressing the Redeem button starts the Redemption Transaction process. Alternatively, the Recipient may elect to change the Merchant associated with the Gift by swiping the screen depicted in FIG. 32 to bring up an Exchange Merchant screen in FIG. 34. The Recipient may select a new Merchant and change from the original Merchant to the new Merchant by touching the Exchange button in FIG. 34. FIG. 23 illustrates a change amount screen that allows the Recipient to select/alter the Gift Value by entering the new (increased) Gift Value and then touching a CHANGE button.

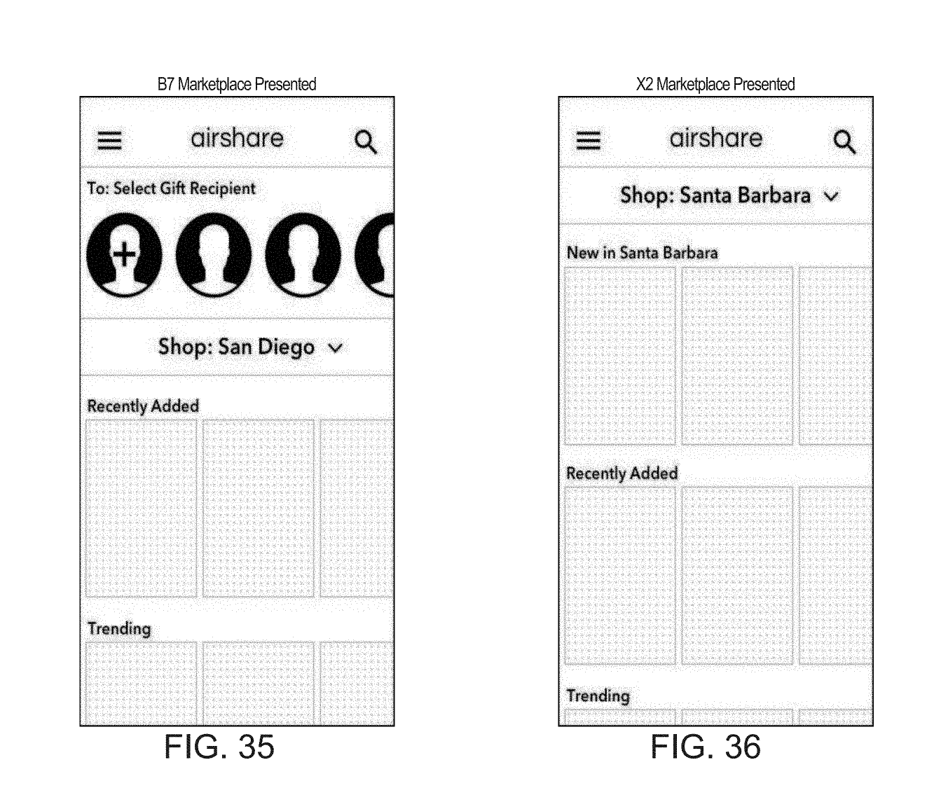

FIG. 35 allows a Giver to select a registered Recipient, in which case the Merchant Marketplace associated with the selected registered Recipient is displayed (e.g., San Diego). The Giver may swipe sideways to scroll through groups of Merchants and select a Merchant to be taken to the selected Merchant's details page. FIG. 36 allows a Giver to browse through a Merchant Marketplace based on the Giver's location (e.g., Santa Barbara). The Giver may swipe sideways to scroll through Merchants and select a Merchant to be taken to the selected Merchant's details page.

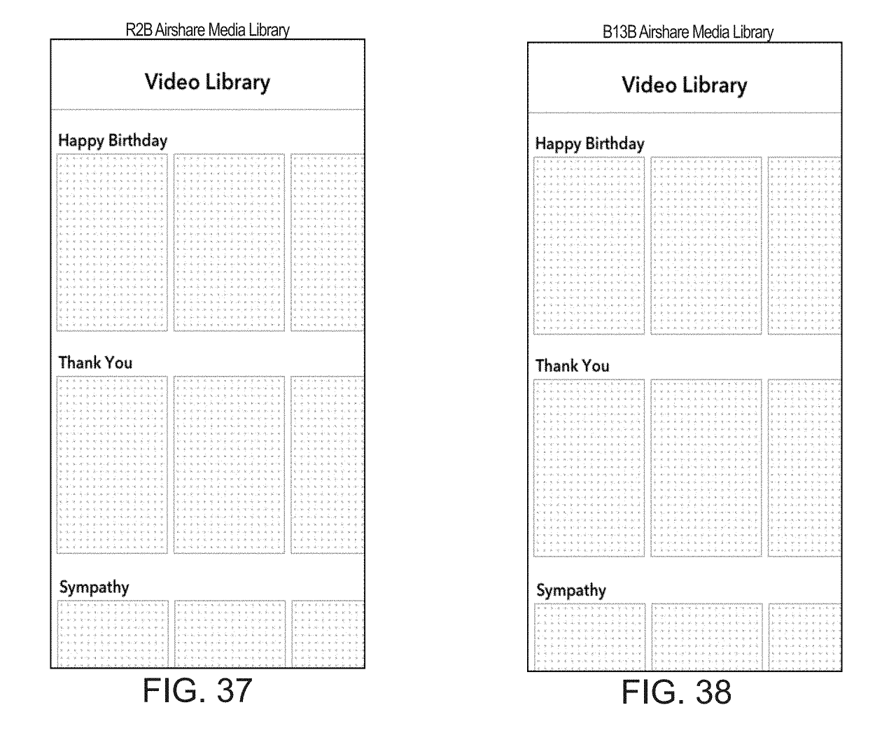

FIGS. 37 and 38 illustrate screens that display the System Video Library to Recipients (FIG. 37) or Givers (FIG. 38 to allow the Recipients and Givers to scroll through categories of related System Video Clips, preview the System Video Clips, and select a desired System Video Clip. The selected System Video Clip may be customized using media such as text and emoji.

In addition, blockchain technology may be used to enhance the security and fault tolerance of the processing of data and transactions and transfer of funds as described herein.

What is claimed is:

1. A data integration system for use by a plurality of customers and a plurality of merchants, comprising:
a control system;
at least one customer interface system associated with each customer, where each customer interface system is operatively connected to the control system to allow customers to
enter into the control system customer data associated with each customer, where the control system generates a customer ID associated with each customer,
enter into the control system media data associated with media clips, where the media data includes a media ID associated with each media clip,
initiate gift processes,
initiate redemption transactions, and
view media clips based on media data;
at least one merchant interface system associated with each merchant,
where each merchant interface system is operatively connected to the control system to allow merchants to
enter into the control system merchant data associated with each merchant, where the control system generates a merchant ID associated with each merchant,
enter into the control system media data associated with media clips, where the media data includes a media ID associated with each media clip,
initiate gift processes, and
participate in redemption transactions initiated by customers;
wherein
the control system
defines at least one merchant list based on associations among merchants, where each merchant list includes at least one merchant ID;
displays on the customer interface systems the at least one vender list to customers initiating gift processes;
generates gift data based on gift processes initiated by customers and merchants, where the gift data includes a gift ID, at least one gift value, at least one giver ID associated with at least one customer or merchant, at least one recipient ID associated with at least one customer, at least one media ID, and at least one merchant ID;
displays on the customer interface system to the at least one customer associated with the at least one recipient ID the at least one media clip associated with the at least one media ID of the gift data;
allows at least one customer associated with at least one recipient ID to change the merchant ID in the gift data associated with that at least one recipient ID;
generates transaction data based on the redemption transaction initiated by the at least one customer associated with each gift ID, where the transaction data includes a transaction ID, a redemption value, at least one media ID, and at least one merchant ID;
validates the redemption transaction based on a comparison of the at least one gift value and the merchant ID associated with each gift ID with the redemption value and merchant ID associated with each transaction ID associated with that gift ID; and
initiates payment to the at least one merchant associated with each transaction ID associated with validated redemption transactions; and
displays on the customer interface system to the customer associated with the giver customer ID or on the merchant interface system to the merchant associated with the giver customer ID the at least one the media clip associated with the media data of the transaction data.

2. A data integration system as recited in claim 1, in which the control system defines the at least one merchant list based on at least one of a location of the merchants, a product offered by the merchants, and a service offered by the merchants.

3. A data integration system as recited in claim 1, in which the control system displays the at least one merchant list to customers based on at least one of a location of the customers, a product desired by the customers, and a service desired by the customers.

4. A data integration system as recited in claim 1, in which the control system:
defines at least one customer list based on associations among customers, where each customer list includes at least one customer ID; and
displays the at least one customer list to merchants initiating gift processes.

5. A data integration system as recited in claim 1, in which the control system defines the at least one Customer list based on at least one of a location of the customers, a product desired by the customers, and a service desired by the customers.

6. A data integration system as recited in claim 5, in which the control system displays the at least one customer list to merchants based on at least one of a location of the merchants, a product offered by the merchants, and a service offered by the merchants.

7. A data integration system as recited in claim 1, in which the at least one media ID of any given set of gift data includes a media ID associated with a media clip created by the at least one customer associated with the giver ID of that given set of gift data.

8. A data integration system as recited in claim 1, in which the at least one media ID of any given set of gift data includes a media ID associated with a media clip created by the at least one merchant associated with the merchant ID of that given set of gift data.

9. A data integration system as recited in claim 1, in which the at least one media ID of any given set of gift data includes:
a first media ID associated with a media clip created by the at least one customer associated with the giver ID of that given set of gift data; and
a second media ID associated with a media clip created by the at least one merchant associated with the merchant ID of that given set of gift data.

10. A data integration system as recited in claim 1, in which the at least one media ID of any given set of transaction data includes a media ID associated with a media clip created by the at least one customer associated with the recipient ID of that given set of transaction data.

11. A data integration system as recited in claim 1, in which the at least one media ID of any given set of transaction data includes a media ID associated with a media clip created by the at least one merchant associated with the merchant ID of that given set of transaction data.

12. A data integration system as recited in claim 1, in which the at least one media ID of any given set of transaction data includes:
a first media ID associated with a media clip created by the at least one customer associated with the recipient ID of that given set of transaction data; and
a second media ID associated with a media clip created by the at least one merchant associated with the merchant ID of that given set of transaction data.

13. A data integration system as recited in claim 12, in which the at least one media ID of any given set of gift data includes:
a first media ID associated with a media clip created by the at least one customer associated with the giver ID of that given set of gift data; and
a second media ID associated with a media clip created by the at least one merchant associated with the merchant ID of that given set of gift data.

14. A data integration system as recited in claim 10, in which:
the gift process is initiated by a given merchant; and
the control system forwards the media clip created by the at least one customer associated with the recipient ID of that given set of transaction data to a social media account associated with the given merchant.

15. A data integration system as recited in claim 1, in which the gift data includes a plurality of recipient IDs associated with a plurality of customers.

16. A method of integrating data for use by a plurality of customers and a plurality of merchants, comprising:
providing at least one customer interface system to allow the customers to
enter into a User database customer data associated with each customer, where a customer ID is associated with each customer, and
enter into a Media database media data associated with media clips, where the media data includes a media ID associated with each media clip entered by the customers;
providing at least one merchant interface system to allow merchants to
enter into the User database merchant data associated with each merchant, where a merchant ID is associated with each merchant,
enter into the Media database media data associated with media clips, where the media data includes a media ID associated with each media clip entered by the merchants,
defining at least one merchant list based on associations among merchants, where each merchant list includes at least one merchant ID;
displaying on the customer interface systems the at least one vender list to customers initiating gift processes;
generating gift data based on gift processes initiated by customers and merchants, where the gift data includes a gift ID, at least one gift value, at least one giver ID associated with at least one customer or merchant, at least one recipient ID associated with at least one customer, at least one media ID, and at least one merchant ID;
using the customer interface system to display to the at least one customer associated with the at least one recipient ID the at least one media clip associated with the at least one media ID of the gift data;
allowing at least one customer associated with at least one recipient ID to change the merchant ID in the gift data associated with that at least one recipient ID;
generating transaction data based on the redemption transaction initiated by the at least one customer associated with each gift ID, where the transaction data includes a transaction ID, a redemption value, at least one media ID, and at least one merchant ID;
validating the redemption transaction by comparing the gift value and the merchant ID associated with the gift ID with the redemption value and merchant ID associated with each transaction ID associated with that gift ID;
initiating payment to the at least one merchant associated with each transaction ID associated with validated redemption transactions; and
displaying on the customer interface system to the customer associated with the giver customer ID or on the merchant interface system to the merchant associated with the giver customer ID the at least one media clip associated with the media data of the transaction data.

17. A method as recited in claim 16, further comprising the step of defining the at least one merchant list based on at least one of a location of the merchants, a product offered by the merchants, and a service offered by the merchants.

18. A method as recited in claim 16, further comprising the step of displaying the at least one merchant list to customers based on at least one of a location of the customers, a product desired by the customers, and a service desired by the customers.

19. A method as recited in claim 16, further comprising the step of:
defines at least one customer list based on associations among customers, where each customer list includes at least one customer ID; and
displays the at least one customer list to merchants initiating gift processes.

20. A method as recited in claim 16, further comprising the step of defining the at least one Customer list based on at least one of a location of the customers, a product desired by the customers, and a service desired by the customers.

21. A method as recited in claim 20, further comprising the step of displaying the at least one customer list to merchants based on at least one of a location of the merchants, a product offered by the merchants, and a service offered by the merchants.

22. A method as recited in claim 16, in which the at least one media ID of any given set of gift data includes a media ID associated with a media clip created by the at least one customer associated with the giver ID of that given set of gift data.

23. A method as recited in claim 16, in which the at least one media ID of any given set of gift data includes a media ID associated with a media clip created by the at least one merchant associated with the merchant ID of that given set of gift data.

24. A method as recited in claim 16, in which the at least one media ID of any given set of gift data includes:
a first media ID associated with a media clip created by the at least one customer associated with the giver ID of that given set of gift data; and
a second media ID associated with a media clip created by the at least one merchant associated with the merchant ID of that given set of gift data.

25. A method as recited in claim 16, in which the at least one media ID of any given set of transaction data includes a media ID associated with a media clip created by the at least one customer associated with the recipient ID of that given set of transaction data.

26. A method as recited in claim 16, in which the at least one media ID of any given set of transaction data includes a media ID associated with a media clip created by the at least one merchant associated with the merchant ID of that given set of transaction data.

27. A method as recited in claim 16, in which the at least one media ID of any given set of transaction data includes:
a first media ID associated with a media clip created by the at least one customer associated with the recipient ID of that given set of transaction data; and
a second media ID associated with a media clip created by the at least one merchant associated with the merchant ID of that given set of transaction data.

28. A method as recited in claim 27, in which the at least one media ID of any given set of gift data includes:
a first media ID associated with a media clip created by the at least one customer associated with the giver ID of that given set of gift data; and
a second media ID associated with a media clip created by the at least one merchant associated with the merchant ID of that given set of gift data.

29. A method as recited in claim 25, in which the gift process is initiated by a given merchant, the method further comprising the step of forwarding the media clip created by the at least one customer associated with the recipient ID of that given set of transaction data to a social media account associated with the given merchant.

30. A method as recited in claim 16, in which the gift data includes a plurality of recipient IDs associated with a plurality of customers.
